(19) United States
(12) Patent Application Publication
(10) Pub. No.: US 2023/0404139 A1
(43) Pub. Date: Dec. 21, 2023

(54) FLANGED INNER HOLE DIAMETER ADJUSTMENT AS AEROSOL ENHANCER

(71) Applicant: Philip Morris Products S.A., Neuchâtel (CH)

(72) Inventor: Farhang MOHSENI, Neuchâtel (CH)

(73) Assignee: Philip Morris Products S.A., Neuchâtel (CH)

(21) Appl. No.: 18/248,100

(22) PCT Filed: Oct. 8, 2021
(86) PCT No.: PCT/EP2021/077970

§ 371 Date: Apr. 6, 2023

(30) Foreign Application Priority Data
Oct. 9, 2020 (EP) 20201169.8
Oct. 9, 2020 (EP) 20201175.5

(51) Int. Cl. A24D 1/20; A24D 1/04

(52) U.S. Cl. CPC A24D 1/20; A24D 1/04

(57) ABSTRACT

An aerosol generating article including a tubular element is provided, the tubular element including: a tubular body defining a cavity extending from a first end of the tubular body to a second end of the tubular body, the cavity having an area as measured perpendicular to a longitudinal direction of the tubular element; and a folded end portion forming a first end wall at a first end of the tubular body, the first end wall delimiting an opening for airflow between the cavity and an exterior of the tubular element, the opening having an area, as measured perpendicular to the longitudinal direction of the tubular element, of from about 0.6 percent to about 60 percent of an area of the cavity.

The present invention relates to an aerosol-generating article comprising an aerosol-generating substrate and adapted to produce an inhalable aerosol upon heating.

Aerosol-generating articles in which an aerosol-generating substrate, such as a tobacco-containing substrate, is heated rather than combusted, are known in the art. Typically, in such heated smoking articles an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

A number of prior art documents disclose aerosol-generating devices for consuming aerosol-generating articles. Such devices include, for example, electrically heated aerosol-generating devices in which an aerosol is generated by the transfer of heat from one or more electrical heater elements of the aerosol-generating device to the aerosol-generating substrate of a heated aerosol-generating article. For example, electrically heated aerosol-generating devices have been proposed that comprise an internal heater blade which is adapted to be inserted into the aerosol-generating substrate. As an alternative, inductively heatable aerosol-generating articles comprising an aerosol-generating substrate and a susceptor element arranged within the aerosol-generating substrate have been proposed by WO 2015/176898.

Aerosol-generating articles in which a tobacco-containing substrate is heated rather than combusted present a number of challenges that were not encountered with conventional smoking articles. For example, it can be desirable to restrict movement of the aerosol-generating substrate within the aerosol-generating article, whilst still ensuring a sufficient level of air flow can pass through the aerosol-generating substrate and the aerosol-generating article. Restricting potential movement of the aerosol-generating substrate is particularly desirable since it can help to improve consistency of performance from one article to another, for example by helping to increase the consistency of interaction between the aerosol-generating substrate and the heater element. This may be particularly relevant for aerosol-generating articles adapted to receive a heater blade, since the act of inserting of the heater blade may otherwise increase the likelihood of displacement of the aerosol-generating substrate.

WO 2013/098405 proposes to include a support element immediately downstream of the aerosol-generating substrate. The support element is provided in the form of an annular shaped tube of filtration material, often referred to as a hollow acetate tube. The support element is configured to resist downstream movement of the aerosol-generating substrate during insertion of a heating blade of an aerosol-generating device into the aerosol-generating substrate. The empty space within the hollow support element provides an opening for aerosol to flow from the aerosol-generating substrate towards the mouth end of the aerosol-generating article.

However, some support elements such as hollow acetate tubes may undesirably filter some of the volatile compounds released from the aerosol-generating substrate. Furthermore, some support elements may not provide desired RTD properties for the aerosol-generating article. Prior art support elements, such as hollow acetate tubes may also be costly, or costly and complicated to manufacture. Prior art support elements, such as hollow acetate tubes may also not be ideally suited to aerosol-generating articles in which a susceptor element is arranged within the aerosol-generating substrate. For example, because the prior art support element may not be ideally suited to the temperatures generated by the susceptor element.

Therefore, it would be desirable to provide a new and improved aerosol-generating article adapted to achieve at least one of the desirable results described above. Further, it would be desirable to provide one such aerosol-generating article that can be manufactured efficiently and at high speed, preferably with a satisfactory RTD and low RTD variability from one article to another.

The present disclosure relates to an aerosol-generating article.

The present disclosure relates to a tubular element for an aerosol-generating article, an aerosol-generating article comprising the tubular element. The tubular element may comprise a tubular body defining a cavity. The cavity may extend from a first end of the tubular body to a second end of the tubular body. The tubular element may further comprise a folded end portion forming a first end wall at the first end of the tubular body. The first end wall may delimit an opening for airflow between the cavity and the exterior of the tubular element.

The present disclosure also relates to an aerosol-generating article comprising the tubular element. The aerosol-generating article may comprise a plurality of elements assembled in the form of a rod. The plurality of elements may comprise a first element comprising an aerosol-generating substrate. The plurality of elements may comprise the tubular element positioned upstream or downstream of the first element. The first end wall of the tubular element may be adjacent to the aerosol-generating substrate.

The cavity of the tubular body may have an area as measured perpendicular to the longitudinal direction of the tubular element. The opening of the first end wall may have an area, as measured perpendicular to the longitudinal direction of the tubular element, of from about 0.6 percent to about 60 percent of the area of the cavity. The opening may have an area, as measured perpendicular to the longitudinal direction of the tubular element, of from about 1.5 percent to about 21 percent of the area of the cavity. The opening may have an area, as measured perpendicular to the longitudinal direction of the tubular element, of from about 2.5 percent to about 9.5 percent of the area of the cavity.

The opening of the first end wall may have an area, as measured perpendicular to the longitudinal direction of the tubular element, of at least about 0.6 percent of the area of the cavity. The opening may have an area, as measured perpendicular to the longitudinal direction of the tubular element, of at least about 1.5 percent of the area of the cavity. The opening may have an area, as measured perpendicular to the longitudinal direction of the tubular element, of at least about 2.5 percent of the area of the cavity. The opening may have an area, as measured perpendicular to the longitudinal direction of the tubular element, of at least about 4 percent of the area of the cavity.

The opening of the first end wall may have an area, as measured perpendicular to the longitudinal direction of the tubular element, of no more than about 0.6 percent of the area of the cavity. The opening may have an area, as measured perpendicular to the longitudinal direction of the tubular element, of no more than about 60 percent of the area of the cavity. The opening may have an area, as measured perpendicular to the longitudinal direction of the tubular element, of no more than about 21 percent of the area of the cavity. The opening may have an area, as measured perpendicular to the longitudinal direction of the tubular element, of no more than about 10 percent of the area of the cavity. The opening may have an area, as measured perpendicular to the longitudinal direction of the tubular element, of no more than about 9.5 percent of the area of the cavity. The opening may have an area, as measured perpendicular to the longitudinal direction of the tubular element, of no more than about 7 percent of the area of the cavity.

The tubular body may have an internal diameter which defines the cavity. The internal diameter of the tubular body may therefore be referred to as the diameter of the cavity. The opening of the first end wall may have a diameter of from about 8 percent to about 77 percent of the diameter of the cavity. The opening may have a diameter of from about 12 percent to about 46 percent of the diameter of the cavity. The opening may have a diameter of from about 15 percent to about 30 percent of the diameter of the cavity.

The opening of the first end wall may have a diameter of at least about 8 percent of the diameter of the cavity. The opening may have a diameter of at least about 12 percent of the diameter of the cavity. The opening may have a diameter of at least about 15 percent of the diameter of the cavity.

The opening of the first end wall may have a diameter of no more than about 77 percent of the diameter of the cavity. The opening may have a diameter of no more than about 50 percent of the diameter of the cavity. The opening may have a diameter of no more than about 46 percent of the diameter of the cavity. The opening may have a diameter of no more than about 30 percent of the diameter of the cavity. The opening may have a diameter of no more than about 25 percent of the diameter of the cavity.

The tubular body may have an outer diameter. The opening of the first end wall may have a diameter of from about 7 percent to about 70 percent of the outer diameter of the tubular body. The opening of the first end wall may have a diameter of from about 11 percent to about 45 percent of the outer diameter of the tubular body. The opening of the first end wall may have a diameter of from about 13 percent to about 27 percent of the outer diameter of the tubular body. The opening of the first end wall may have a diameter of from about 27 percent to about 42 percent of the outer diameter of the tubular body.

The opening of the first end wall may have a diameter of at least about 7 percent of the outer diameter of the tubular body. The opening of the first end wall may have a diameter of at least about 10 percent of the outer diameter of the tubular body. The opening of the first end wall may have a diameter of at least about 11 percent of the outer diameter of the tubular body. The opening of the first end wall may have a diameter of at least about 13 percent of the outer diameter of the tubular body.

The opening of the first end wall may have a diameter of no more than about 70 percent of the outer diameter of the tubular body. The opening of the first end wall may have a diameter of no more than about 45 percent of the outer diameter of the tubular body. The opening of the first end wall may have a diameter of no more than about 42 percent of the outer diameter of the tubular body. The opening of the first end wall may have a diameter of no more than about 30 percent of the outer diameter of the tubular body. The opening of the first end wall may have a diameter of no more than about 27 percent of the outer diameter of the tubular body.

The opening may have a diameter of from about 0.5 millimetres to about 5 millimetres. The opening may have a diameter of from about 0.8 millimetres to about 3 millimetres. The opening may have a diameter of from about 1 millimetres to about 2 millimetres. The opening may have a diameter of from about 2 millimetres to about 3 millimetres. The opening may have a diameter of from about 0.5 millimetres to about 5 millimetres.

The opening may have a diameter of at least about 0.5 millimetres. The opening may have a diameter of at least about 0.8 millimetres. The opening may have a diameter of at least about 1 millimetres. The opening may have a diameter of at least about 1.5 millimetres. The opening may have a diameter of at least about 2 millimetres.

The opening may have a diameter of no more than about 5 millimetres. The opening may have a diameter of no more than about 3 millimetres. The opening may have a diameter of no more than about 2 millimetres.

Preferably, the cavity has a constant cross-section along its length, as measured perpendicular to the longitudinal direction of the tubular element. That is, preferably the cross-section of the cavity at a first longitudinal position of the tubular body is the same as the cross-section of the cavity at second and further longitudinal position of the tubular body. Consequently, the area of the cavity may be constant along the length of the tubular body. However, if the cavity does not has a constant cross-section along its length (for example, because the internal surface of the hollow tubular body tapers along the length of the hollow tubular body), then the area of the cavity as measured as measured perpendicular to the longitudinal direction of the tubular element is taken to be the smallest such area of the cavity along the length of the tubular body.

The aerosol-generating article may further comprise an outer wrapper circumscribing at least the tubular element.

The outer wrapper may define an outer surface of the aerosol-generating article. The outer wrapper may also circumscribe the first element. The outer wrapper may circumscribe all of the plurality of elements of the aerosol-generating article which are assembled in the form of a rod. The outer wrapper may be a tipping wrapper as described below. The outer wrapper circumscribing the tubular element may be a paper wrapper or a non-paper wrapper. Suitable paper wrappers for use in specific embodiments of the invention are known in the art and include, but are not limited to: cigarette papers; and filter plug wraps. Suitable non-paper wrappers for use in specific embodiments of the invention are known in the art and include, but are not limited to sheets of homogenised tobacco materials. In certain preferred embodiments, the wrapper may be formed of a laminate material comprising a plurality of layers. Preferably, the wrapper is formed of an aluminium co-laminated sheet. The use of a co-laminated sheet comprising aluminium advantageously prevents combustion of the outer wrapper in the event that the aerosol-generating substrate should be ignited, rather than heated in the intended manner.

According to the present invention there is provided a tubular element for an aerosol-generating article. The tubular element comprises: a tubular body defining a cavity extending from a first end of the tubular body to a second end of the tubular body; and a folded end portion forming a first end wall at the first end of the tubular body, the first end wall delimiting an opening for airflow between the cavity and the exterior of the tubular element.

The term “aerosol-generating article” is used herein to denote an article wherein an aerosol-generating substrate is heated to produce and deliver inhalable aerosol to a consumer. As used herein, the term “aerosol-generating substrate” denotes a substrate capable of releasing volatile compounds upon heating to generate an aerosol.

A conventional cigarette is lit when a user applies a flame to one end of the cigarette and draws air through the other end. The localised heat provided by the flame and the oxygen in the air drawn through the cigarette causes the end of the cigarette to ignite, and the resulting combustion generates an inhalable smoke. By contrast, in heated aerosol-generating articles, an aerosol is generated by heating a flavour generating substrate, such as tobacco. Known heated aerosol-generating articles include, for example, electrically heated aerosol-generating articles and aerosol-generating articles in which an aerosol is generated by the transfer of heat from a combustible fuel element or heat source to a physically separate aerosol forming material. For example, aerosol-generating articles according to the invention find particular application in aerosol-generating systems comprising an electrically heated aerosol-generating device having an internal heater blade which is adapted to be inserted into the rod of aerosol-generating substrate. Aerosol-generating articles of this type are described in the prior art, for example, in EP 0822670.

As used herein, the term “aerosol-generating device” refers to a device comprising a heater element that interacts with the aerosol-generating substrate of the aerosol-generating article to generate an aerosol.

As used herein the term “rod” is used to denote a generally cylindrical element of substantially circular, oval or elliptical cross-section.

As used herein, the term “longitudinal” refers to the direction corresponding to the main longitudinal axis of the aerosol-generating article, which extends between the upstream and downstream ends of the aerosol-generating article. As used herein, the terms “upstream” and “downstream” describe the relative positions of elements, or portions of elements, of the aerosol-generating article in relation to the direction in which the aerosol is transported through the aerosol-generating article during use.

During use, air is drawn through the aerosol-generating article in the longitudinal direction. The term “transverse” refers to the direction that is perpendicular to the longitudinal axis. Any reference to the “cross-section” of the aerosol-generating article or a component of the aerosol-generating article refers to the transverse cross-section unless stated otherwise.

The term “length” denotes the dimension of a component of the aerosol-generating article in the longitudinal direction. For example, it may be used to denote the dimension of the first element comprising the aerosol-generating substrate or the hollow tubular element in the longitudinal direction.

As used herein, the term “tubular element” is used to denote a generally elongate element defining a lumen or airflow passage along a longitudinal axis thereof. In particular, the term “tubular” will be used in the following with reference to a tubular element having a tubular body with a substantially cylindrical cross-section and defining at least one airflow conduit establishing an uninterrupted fluid communication between an upstream end of the tubular body and a downstream end of the tubular body. However, it will be understood that alternative geometries (for example, alternative cross-sectional shapes) of the tubular body may be possible.

As used herein, the term “elongate” means that an element has a length dimension that is greater than its width dimension or its diameter dimension, for example twice or more its width dimension or its diameter dimension.

In the context of the present invention the tubular body of the tubular element provides an unrestricted flow channel. This means that the tubular body portion of the tubular element provides a negligible level of resistance to draw (RTD). The flow channel should therefore be free from any components that would obstruct the flow of air in a longitudinal direction. Preferably, the flow channel is substantially empty. In such a case, the tubular body of the tubular element defines an empty cavity.

The tubular element of the present invention provides an improved component for an aerosol-generating article. By forming the tubular element from a tubular body defining a cavity extending from a first end of the tubular body to a second end of the tubular body, a relatively large proportion of the tubular element can be empty and permit unimpeded airflow. Where the tubular element is downstream of an aerosol-generating substrate, this may help to improve cooling and nucleation of the aerosol. Furthermore, such a configuration may also help to minimise filtration of any compounds released from the aerosol-generating substrate, particularly when compared to prior art hollow acetate tubes.

By providing the tubular element with a folded end portion forming a first end wall at the first end of the tubular body, the tubular element can be configured to have a desired RTD through configuration of the size and shape of the first end wall. In particular, the tubular element and its first end wall can be manufactured efficiently and at high speed, with a satisfactory RTD and low RTD variability from one article to another. Furthermore, the configuration of the tubular element and its first end wall means that RTD can be localised at a specific longitudinal position of the tubular element, rather than being continuously distributed along the length of the tubular element.

Where the first end wall of the tubular element is adjacent to an aerosol-generating substrate, the first end wall may provide a barrier which may restrict movement of the aerosol-generating substrate. This arrangement can also advantageously enable one or both of air and aerosol to flow through the opening into the cavity.

The barrier provided by the first end wall of the tubular element may be more effective than a barrier provided by an end of a hollow acetate tube, since the first end wall may be less deformable than the end of the hollow acetate tube. The construction of the tubular element may also be better suited to withstanding the temperatures generated by a heating blade or susceptor element.

By providing the opening of the first end wall with a size as defined above either in respect of an absolute value or with reference to one or more of: the area of the cavity of the tubular body; the diameter of the cavity of the tubular body; and the outer diameter of the tubular body, the RTD of the tubular element may be precisely tuned to a desired value. Furthermore, where the tubular element is positioned downstream of an aerosol-generating substrate, selection of such a size of opening may help in the formulation of an aerosol having desirable properties, such as a desirably high level of aerosol constituents including one or both of nicotine and glycerin. The term ‘adjacent to’ is used herein in respect of the tubular element and first element to indicate that the tubular element is longitudinally positioned next to the first element in the rod of assembled elements. In particular, this term indicates that there are no other elements of the assembled rod disposed between the first element and the tubular element in the longitudinal direction.

The first element and tubular element may be adjacent to one another and in contact with one another. For example, the first end wall of the tubular element may be adjacent to the aerosol-generating substrate and in contact with the aerosol-generating substrate.

The first element and tubular element may be adjacent to one another but not in contact with one another because a small gap of empty space separates the first element from the tubular element in the longitudinal direction of the aerosol-generating article. For example, the first end wall of the tubular element may be adjacent to the aerosol-generating substrate but not in contact with the aerosol-generating substrate. The gap may be 2 millimetres or less. The gap may be 1 millimetre or less.

The first element may be referred to as an aerosol-generating element.

The tubular element may be positioned upstream of the first element. In such embodiments, the tubular element may be referred to as an upstream tubular element.

The tubular element may be positioned downstream of the first element. In such embodiments, the tubular element may be referred to as a downstream tubular element.

The aerosol-generating article may comprise two tubular elements, one being a first tubular element positioned downstream of the first element and the other being a second tubular element positioned upstream of the first element. The first and second tubular elements may each have any feature or combination of features, which are described above or below in respect of the tubular element of the invention.

For example, the tubular element may be a first tubular element, which is positioned downstream of the aerosol forming substrate with the first end wall of the first tubular element being adjacent to the downstream end of the aerosol-generating substrate. In such embodiments, the aerosol-generating article may further comprise a second tubular element. The second tubular element may be positioned upstream of the first element. The second tubular element may comprise a tubular body defining a cavity extending from a first end of the tubular body to a second end of the tubular body; and a folded end portion forming a first end wall at the first end of the tubular body, the first end wall delimiting an opening for airflow between the cavity and the exterior of the second tubular element. The first end wall of the second tubular element may be adjacent to the upstream end of the aerosol-generating substrate. Therefore, in such embodiments, the first element comprising the aerosol-generating substrate may be sandwiched between first and second tubular elements, where each tubular element has a folded end portion which provides a respective end wall adjacent to the upstream or downstream end of the first element. In such embodiments, the second tubular element may be referred to as an upstream tubular element, and the first tubular element may be referred to as a downstream tubular element.

The second tubular element may further comprise a folded end portion forming a second end wall at the second end of its tubular body. The second end wall of the second tubular element may delimit an opening for airflow between the cavity and the exterior of the second tubular element. The opening delimited by the second end wall of the second tubular element may be smaller than the opening delimited by the first end wall of the second tubular element. For example, the size of the opening delimited by the second end wall of the second tubular element may be between about 20 percent and about 80 percent of the size of the opening delimited by the first end wall of the second tubular element. The size of the opening delimited by the second end wall of the second tubular element may be between about 40 percent and about 60 percent of the size of the opening delimited by the first end wall of the second tubular element, more preferably between about 45 percent and about 55 percent of the size of the opening delimited by the first end wall of the second tubular element.

In general terms, where the tubular element of the invention comprises two end walls each having a respective opening, the size of the opening delimited by the second end wall of the tubular element may be between about 20 percent and about 80 percent of the size of the opening delimited by the first end wall of the tubular element.

The second tubular element may be the most upstream component of the aerosol-generating article. For example, the upstream end of the aerosol-generating article may be defined by the upstream end of the second tubular element.

As will be described in more detail below, the aerosol-generating article may further comprise a ventilation zone at a location along the tubular element. Where the aerosol-generating article comprises the first and second tubular elements described above, the ventilation zone is preferably located along the first tubular element.

The first end wall may extend substantially transverse to the longitudinal direction of the aerosol generating article. The first end wall may extend substantially transverse to the longitudinal direction of the tubular body.

The first end wall may extend partially into the cavity of the tubular body and forms an angle of less than 90 degrees with the inner surface of the tubular body, more preferably an angle of less than 80 degrees with the inner surface of the tubular body, even more preferably angle of less than 70 degrees with the inner surface of the tubular body. This may be achieved by ensuring that, during manufacture of the tubular element, a folding force is applied to the tubular element such that at least part of the first end portion of the tubular element is pushed into the cavity of the tubular body. Such arrangements may advantageously increase the likelihood of the first end wall remaining stationary with respect to the tubular body after the tubular element has been manufactured. In particular, such arrangements may help to overcome any natural resilience in the material forming the tubular element, such that the folded end portion of the tubular element is less likely to revert towards its pre-folded condition after manufacture.

The opening delimited by the first end wall may be the only opening in the first end wall. The opening may be disposed in a generally radially central position of the tubular element. The first end wall may be generally annular shaped.

The first end wall may extend from a fold point on the tubular element and towards a radially central position of the tubular element. The fold point may generally correspond to the first end of the tubular body of the tubular element.

Preferably, at least the first portion of the tubular element forming the first end wall is substantially air impermeable. Put another way, preferably the first end wall is substantially non-porous. Preferably the first end wall does not comprise any perforations. The material forming the first end wall may have a porosity of less than 2000 Coresta units. The material forming the first end wall may have a porosity of less than 1000 Coresta units. The material forming the first end wall may have a porosity of less than 500 Coresta units.

Preferably, the tubular body of the tubular element is substantially air impermeable. Put another way, preferably the tubular body is substantially non-porous. Preferably the tubular body does not comprise any perforations. The material forming the tubular body may have a porosity of less than 2000 Coresta units. The material forming the tubular body may have a porosity of less than 1000 Coresta units. The material forming the tubular body may have a porosity of less than 500 Coresta units.

Where the first element comprises a susceptor element within the aerosol-generating substrate, the opening in the first wall may be generally aligned with the radial position of the susceptor element. This can advantageously help to keep a distance between the first end wall of the tubular element and the susceptor of the first element. Keeping such a distance may help to mitigate any undesirable heating of the first end wall of the tubular element by the susceptor element.

The present disclosure also includes a method of forming a tubular element for the aerosol-generating article of the invention. The method may include the step of providing tubular element precursor comprising: a tubular body defining a cavity extending from a first end of the tubular body to a second end of the tubular body; and a first end portion adjacent to and integrally formed with the first end of the tubular body. The method further includes the step of applying a folding force to the tubular element precursor to bend or fold the first end portion about a fold point corresponding to a first end of the tubular body, the folding force being applied such that at least part of the first end portion of the tubular element extends into the cavity of the tubular body. The method may further include the step of releasing the folding force to so that the first end portion of the tubular element partially reverts back along its folding path and reaches a positon in which the first end portion extends substantially transverse to the longitudinal direction of the tubular body to thereby form a first end wall at the first end of the tubular body, with the first end wall delimiting an opening for airflow between the cavity and the exterior of the tubular element.

The present disclosure also includes a tubular element for an aerosol-generating article. The tubular element may comprise: a tubular body defining an empty cavity extending from a first end of the tubular body to a second end of the tubular body; a first folded end portion forming a first end wall at the first end of the tubular body, the first end wall delimiting a first opening for airflow between the empty cavity and the exterior of the tubular element; and a second folded end portion forming a second end wall at the second end of the tubular body, the second end wall delimiting a second opening for airflow between the empty cavity and the exterior of the tubular element. The tubular element may include or be combined with any feature or combination of features, which are described above or below in respect of the tubular element of the aerosol-generating article of the invention.

The tubular element preferably has an outer diameter that is approximately equal to the outer diameter of the aerosol-generating article. Where the first element is formed as a rod, the tubular element preferably has an outer diameter that is approximately equal to the outer diameter of the first element.

The tubular element may have an outer diameter of between 6 millimetres and 10 millimetres, for example of between 7 millimetres and 9 millimetres or of between 7.5 millimetres and 8.5 millimetres. In a preferred embodiment, the tubular element has an external diameter of 7.8 millimetres plus or minus 10 percent.

Preferably, the tubular element has an equivalent internal diameter of at least about 5.5 millimetres. More preferably, the tubular element has an equivalent internal diameter of at least about 6 millimetres. Even more preferably, the tubular element has an equivalent internal diameter of at least about 7 millimetres. The term “equivalent internal diameter” is used herein to denote the diameter of a circle having the same surface area of a cross-section of the airflow conduit internally defined by the hollow tubular segment. A cross-section of the airflow conduit may have any suitable shape. However, as described briefly above, a circular cross-section is preferred—that is, the hollow tubular segment is effectively a cylindrical tube. In that case, the equivalent internal diameter of the hollow tubular segment effectively coincides with the internal diameter of the cylindrical tube.

The equivalent internal diameter of the hollow tubular segment is preferably less than about 10 millimetres. More preferably, the equivalent internal diameter of the hollow tubular segment is less than about 9.5 millimetres, even more preferably less than 9 millimetres.

Preferably, the tubular element has a wall thickness of at least about 0.1 millimetres, more preferably at least about 0.2 millimetres.

Preferably, the tubular element has a wall thickness of less than about 1.5 millimetres, preferably less than about 1.25 millimetres. In a preferred embodiment, the tubular element has a wall thickness of less than about 1 millimetre.

The tubular element therefore preferably has a wall thickness of between about 0.1 millimetres and about 1.5 millimetres, or between about 0.2 millimetres and about 1.25 millimetres, or between about 0.5 millimetres and about 1 millimetre.

Providing the tubular element with such wall thickness can help to improve the tubular body's resistance to collapse or deformation, whilst still enabling the first end wall to be formed by a folded end portion of the tubular element.

The wall thickness of the tubular element may be the same as the wall thickness of one or both of the tubular body and the first end wall.

The length of the tubular element may be substantially the same as the length of the tubular body.

Preferably, the tubular element has a length of at least about 10 millimetres, more preferably at least about 15 millimetres.

Preferably, the tubular element has a length of less than about 30 millimetres, preferably less than about 25 millimetres, even more preferably less than about 20 millimetres.

The tubular element may have a length of from about 10 millimetres to about 30 millimetres, preferably from about 15 millimetres to about 25 millimetres, more preferably from about 15 millimetres to about 20 millimetres. For example, in one particularly preferred embodiment, the tubular element has a length of 18 millimetres. Such lengths may be particularly preferred in embodiments where the tubular element is positioned downstream of the aerosol-generating substrate with the first end wall of the tubular element being adjacent to the downstream end of the aerosol-generating substrate.

The tubular element may have a length of from about 5 millimetres to about 20 millimetres, preferably from about 8 millimetres to about 15 millimetres, more preferably from about 10 millimetres to about 13 millimetres. For example, in one particularly preferred embodiment, the tubular element has a length of 12 millimetres. Such lengths may be particularly preferred in embodiments where the tubular element is positioned upstream of the aerosol-generating substrate with the first end wall of the tubular element being adjacent to the upstream end of the aerosol-generating substrate.

Preferably, the tubular element is adapted to generate a RTD between approximately 0 millimetres H₂O (about 0 Pa) to approximately 20 millimetres H₂O (about 100 Pa), more preferably between approximately 0 millimetres H₂O (about 0 Pa) to approximately 10 millimetres H₂O (about 100 Pa).

The tubular element is preferably formed from a paper material, such as paper, paperboard or cardboard. The tubular element may be formed from a plurality of overlapping paper layers, such as a plurality of parallel wound paper layers or a plurality of spirally wound paper layers. Forming the tubular element from a plurality of overlapping paper layers can help to improve the tubular body's resistance to collapse or deformation, whilst still enabling the first end wall to be formed by a folded end portion of the tubular element.

The tubular element may comprise at least two paper layers. The tubular element may comprise fewer than eleven paper layers.

Where the tubular element is formed from a paper material, the paper material may have a basis weight of at least about 90 grams per square metre. The paper material may have a basis weight of less than about 300 grams per square metre. The paper material may have a basis weight of from about 100 to about 200 grams per square metre. Providing the tubular element with such wall basis weight can help to improve the tubular body's resistance to collapse or deformation, whilst still enabling the first end wall to be formed by a folded end portion of the tubular element.

The first end wall of the tubular element may comprise a hydrophobic region comprising hydrophobic groups covalently bonded to the first end wall. Where the tubular element comprises a second end wall, the second end wall may also comprise a hydrophobic region.

In another aspect, the hydrophobic region has a water contact angle of at least about 90 degrees or at least about 100 degrees and a Cobb measurement value (at 60 seconds) of about 40 g/m² or less, or about 35 g/m² or less.

The hydrophobic region may be produced by a process comprising the steps of: applying a liquid composition comprising a fatty acid halide to a surface of the first end wall and maintaining the surface at a temperature of about 120 degrees Celsius to about 180 degrees Celsius. The fatty acid halide reacts in situ with protogenic groups of material in the hydrophobic region resulting in the formation of fatty acid esters.

The term “hydrophobic” refers to a surface exhibiting water repelling properties. One useful way to determine this is to measure the water contact angle. The “water contact angle” is the angle, conventionally measured through the liquid, where a liquid/vapour interface meets a solid surface. It quantifies the wettability of a solid surface by a liquid via the Young equation.

This hydrophobic region has a Cobb water absorption (ISO535:1991) value (at 60 seconds) of less than about 40 g/m², less than about 35 g/m², less than about 30 g/m², or less than about 25 g/m².

The hydrophobic region has a water contact angle of at least about 90 degrees, at least about 95 degrees, at least about 100 degrees, at least about 110 degrees, at least about 120 degrees, at least about 130 degrees at least about 140 degrees, at least about 150 degrees, at least about 160 degrees, or at least about 170 degrees. Hydrophobicity is determined by utilizing the TAPPI T558 om-97 test and the result is presented as an interfacial contact angle and reported in “degrees” and can range from near zero degrees to near 180 degrees. Where no contact angle is specified along with the term hydrophobic, the water contact angle is at least 90 degrees.

In accordance with the present disclosure there is provided an aerosol-generating article for generating an inhalable aerosol upon heating. The aerosol-generating article comprises a first element comprising an aerosol-generating substrate and a tubular element. The aerosol-generating article comprises a downstream section at a location downstream of the aerosol-generating substrate. The downstream section may comprise one or more downstream elements, such as the tubular element.

The downstream section may comprise a mouthpiece element. The mouthpiece element may extend all the way to a mouth end of the aerosol-generating article.

The mouthpiece element may extend all the way to the downstream end of the aerosol-generating substrate. Where the mouthpiece element extends all the way from the downstream end of the aerosol-generating substrate to the mouth end of the aerosol-generating article, the mouthpiece element may be the only element in the downstream section of the aerosol-generating article. As an alternative, when the tubular element is disposed downstream of the aerosol-generating substrate, the mouthpiece element may be located downstream of the first tubular element. In such embodiments, the mouthpiece element may extend all the way to the downstream end of the tubular element. Put another way, the mouthpiece element is located immediately downstream of the tubular element. By way of example, the mouthpiece element may abut the downstream end of the tubular element.

The mouthpiece element is preferably located at the downstream end or mouth end of the aerosol-generating article. The mouthpiece element preferably comprises at least one mouthpiece filter segment for filtering the aerosol that is generated from the aerosol-generating substrate. For example, the mouthpiece element may comprise one or more segments of a fibrous filtration material. Suitable fibrous filtration materials would be known to the skilled person. Particularly preferably, the at least one mouthpiece filter segment comprises a cellulose acetate filter segment formed of cellulose acetate tow.

The mouthpiece element may consist of a single mouthpiece filter segment. In alternative embodiments, the mouthpiece element includes two or more mouthpiece filter segments axially aligned in an abutting end to end relationship with each other.

\the mouthpiece element may comprise a mouth end cavity. The mouth end cavity may be defined by a hollow tubular element provided at the downstream end of the mouthpiece. Alternatively, the mouth end cavity may be defined by an outer wrapper of the aerosol-generating article at the mouth end.

The mouthpiece element may optionally comprise a flavourant, which may be provided in any suitable form. For example, the mouthpiece element may comprise one or more capsules, beads or granules of a flavourant, or one or more flavour loaded threads or filaments.

Preferably, the mouthpiece element has a low particulate filtration efficiency.

Preferably, the mouthpiece is formed of a segment of a fibrous filtration material.

Preferably, the mouthpiece element is circumscribed by a plug wrap. Preferably, the mouthpiece element is unventilated such that air does not enter the aerosol-generating article along the mouthpiece element.

The mouthpiece element is preferably connected to one or more of the adjacent upstream components of the aerosol-generating article, such as the tubular element or tubular elements, by means of a tipping wrapper.

Preferably, the mouthpiece element has an RTD of less than about 25 millimetres H₂O. More preferably, the mouthpiece element has an RTD of less than about 20 millimetres H₂O. Even more preferably, the mouthpiece element has an RTD of less than about 15 millimetres H₂O.

Values of RTD from about 10 millimetres H₂O to about to about 15 millimetres H₂O are particularly preferred because a mouthpiece element having one such RTD is expected to contribute minimally to the overall RTD of the aerosol-generating article substantially does not exert a filtration action on the aerosol being delivered to the consumer.

The mouthpiece element preferably has an external diameter that is approximately equal to the external diameter of the aerosol-generating article. The mouthpiece element may have an external diameter of between about 5 millimetres and about 10 millimetres, or between about 6 millimetres and about 8 millimetres. In a preferred embodiment, the mouthpiece element has an external diameter of approximately 7.2 millimetres.

The mouthpiece element may have a length of at least about 10 millimetres, more preferably at least about 11 millimetres, more preferably at least about 12 millimetres. The mouthpiece element may have a length of less than about 25 millimetres, more preferably less than about 20 millimetres, more preferably less than about 15 millimetres.

The mouthpiece element may have a length from about 10 millimetres to about 25 millimetres, more preferably from about 10 millimetres to about 20 millimetres, even more preferably from about 10 millimetres to about 15 millimetres. The mouthpiece element may have a length from about 11 millimetres to about 25 millimetres, more preferably from about 11 millimetres to about 20 millimetres, even more preferably from about 11 millimetres to about 15 millimetres. The mouthpiece element may have a length from about 12 millimetres to about 25 millimetres, more preferably from about 12 millimetres to about 20 millimetres, even more preferably from about 12 millimetres to about 20 millimetres.

In a preferred embodiment, the mouthpiece element has a length of approximately 12 millimetres.

The provision of a relatively long mouthpiece element in the aerosol-generating article may allow the inclusion of a capsule, or allow the article to be more rigid at the position that the user applies the lips, or both.

The aerosol-generating article may comprise a ventilation zone at a location along the downstream section. Where the downstream section comprises the tubular element, the ventilation zone may be provided at a location along the tubular element.

In some embodiments, there is no ventilation zone about the tubular body of the tubular element. Alternatively, the tubular element of the invention may comprise a ventilation zone at a location along the tubular body of the tubular element. Features of the ventilation zone are described below in respect of the aerosol-generating article. However, it will be appreciated that they may also apply to directly to the tubular element itself.

The ventilation zone may be located between about 5 millimetres and about 15 millimetres from the folded end portion of the tubular element. The ventilation zone may be located at least 2 millimetres from the folded end portion of the tubular element, more preferably at least 3 millimetres from the folded end portion of the tubular element, even more preferably at least 5 millimetres from the folded end portion of the tubular element.

The ventilation zone may be located less than 20 millimetres from the folded end portion of the tubular element, more preferably less than 15 millimetres from the folded end portion of the tubular element, even more preferably less than 10 millimetres from the folded end portion of the tubular element.

Where the tubular element is a first tubular element positioned downstream of the aerosol forming substrate, the ventilation zone is preferably located in an downstream section of the first tubular element. Preferably, the ventilation zone is located between about 1 millimetres and about 10 millimetres from the downstream end of the first tubular element, more preferably between about 2 millimetres and about 8 millimetres from the downstream end of the first tubular element, even more preferably between about 3 millimetres and about 6 millimetres from the downstream end of the first tubular element.

Preferably, the ventilation zone is located at least 1 millimetres from the downstream end of the first tubular element, more preferably the ventilation zone is located at least 2 millimetres from the downstream end of the first tubular element, even more preferably the ventilation zone is located at least 3 millimetres from the downstream end of the first tubular element.

Preferably, the ventilation zone is located less than 10 millimetres from the downstream end of the first tubular element, more preferably the ventilation zone is located less than 8 millimetres from the downstream end of the first tubular element, even more preferably the ventilation zone is located less than 6 millimetres from the downstream end of the first tubular element.

The ventilation zone may comprise a plurality of perforations through the peripheral wall of the ventilated element, which may be the tubular element. Preferably, the ventilation zone comprises at least one circumferential row of perforations, the ventilation zone may comprise two circumferential rows of perforations. For example, the perforations may be formed online during manufacturing of the aerosol-generating article. Preferably, each circumferential row of perforations comprises from 8 to 30 perforations.

An aerosol-generating article in accordance with the present invention may have a ventilation level of at least about 5 percent.

The term “ventilation level” is used throughout the present specification to denote a volume ratio between of the airflow admitted into the aerosol-generating article via the ventilation zone (ventilation airflow) and the sum of the aerosol airflow and the ventilation airflow. The greater the ventilation level, the higher the dilution of the aerosol flow delivered to the consumer.

The aerosol-generating article may typically have a ventilation level of at least about 10 percent, preferably at least about 15 percent, more preferably at least about 20 percent.

In preferred embodiments, the aerosol-generating article has a ventilation level of at least about 25 percent. The aerosol-generating article preferably has a ventilation level of less than about 60 percent. The aerosol-generating article may have a ventilation level of less than or equal to about 45 percent. More preferably, the aerosol-generating article may have a ventilation level of less than or equal to about 40 percent, even more preferably less than or equal to about 35 percent.

In a particularly preferred embodiments, the aerosol-generating article has a ventilation level of about 30 percent. The aerosol-generating article may have a ventilation level from about 20 percent to about 60 percent, preferably from about 20 percent to about 45 percent, more preferably from about 20 percent to about 40 percent The aerosol-generating article may have a ventilation level from about 25 percent to about 60 percent, preferably from about 25 percent to about 45 percent, more preferably from about 25 percent to about 40 percent. In further embodiments, the aerosol-generating article has a ventilation level from about 30 percent to about 60 percent, preferably from about 30 percent to about 45 percent, more preferably from about 30 percent to about 40 percent.

In some particularly preferred embodiments, the aerosol-generating article has a ventilation level from about 28 percent to about 42 percent. In some particularly preferred embodiments, the aerosol-generating article has a ventilation level of about 30 percent.

Embodiments where the aerosol-generating comprises a first tubular element downstream of the aerosol-generating substrate with a ventilation zone provided at a location along the first tubular element may provide a number of advantages. For example, and without wishing to be bound by theory, the inventors have found that the temperature drop caused by the admission of cooler, external air into the first tubular element via the ventilation zone may have an advantageous effect on the nucleation and growth of aerosol particles.

Formation of an aerosol from a gaseous mixture containing various chemical species depends on a delicate interplay between nucleation, evaporation, and condensation, as well as coalescence, all the while accounting for variations in vapour concentration, temperature, and velocity fields. The so-called classical nucleation theory is based on the assumption that a fraction of the molecules in the gas phase are large enough to stay coherent for long times with sufficient probability (for example, a probability of one half). These molecules represent some kind of a critical, threshold molecule clusters among transient molecular aggregates, meaning that, on average, smaller molecule clusters are likely to disintegrate rather quickly into the gas phase, while larger clusters are, on average, likely to grow. Such critical cluster is identified as the key nucleation core from which droplets are expected to grow due to condensation of molecules from the vapour. It is assumed that virgin droplets that just nucleated emerge with a certain original diameter, and then may grow by several orders of magnitude. This is facilitated and may be enhanced by rapid cooling of the surrounding vapour, which induces condensation. In this connection, it helps to bear in mind that evaporation and condensation are two sides of one same mechanism, namely gas-liquid mass transfer. While evaporation relates to net mass transfer from the liquid droplets to the gas phase, condensation is net mass transfer from the gas phase to the droplet phase. Evaporation (or condensation) will make the droplets shrink (or grow), but it will not change the number of droplets.

In this scenario, which may be further complicated by coalescence phenomena, the temperature and rate of cooling can play a critical role in determining how the system responds. In general, different cooling rates may lead to significantly different temporal behaviours as concerns the formation of the liquid phase (droplets), because the nucleation process is typically nonlinear. Without wishing to be bound by theory, it is hypothesised that cooling can cause a rapid increase in the number concentration of droplets, which is followed by a strong, short-lived increase in this growth (nucleation burst). This nucleation burst would appear to be more significant at lower temperatures. Further, it would appear that higher cooling rates may favour an earlier onset of nucleation. By contrast, a reduction of the cooling rate would appear to have a favourable effect on the final size that the aerosol droplets ultimately reach.

Therefore, the rapid cooling induced by the admission of external air into the first tubular element via the ventilation zone can be favourably used to favour nucleation and growth of aerosol droplets. However, at the same time, the admission of external air into the first tubular element has the immediate drawback of diluting the aerosol stream delivered to the consumer.

The inventors have surprisingly found that the diluting effect on the aerosol—which can be assessed by measuring, in particular, the effect on the delivery of aerosol former (such as glycerol) included in the aerosol-generating substrate—is advantageously minimised when the ventilation level is within the ranges described above. In particular, ventilation levels between 25 percent and 50 percent, and even more preferably between 28 and 42 percent, have been found to lead to particularly satisfactory values of glycerin delivery. At the same time, the extent of nucleation and, as a consequence, the delivery of nicotine and aerosol-former (for example, glycerol) are enhanced.

The inventors have surprisingly found how the favourable effect of enhanced nucleation promoted by the rapid cooling induced by the introduction of ventilation air into the article is capable of significantly countering the less desirable effects of dilution. As such, satisfactory values of aerosol delivery are consistently achieved with aerosol-generating articles in accordance with the disclosure.

This is particularly advantageous with “short” aerosol-generating articles, such as ones wherein a length of the first element comprising the aerosol-generating substrate is less than about 40 millimetres, preferably less than 25 millimetres, even more preferably less than 20 millimetres, or wherein an overall length of the aerosol-generating article is less than about 70 millimetres, preferably less than about 60 millimetres, even more preferably less than 50 millimetres. As will be appreciated, in such aerosol-generating articles, there is little time and space for the aerosol to form and for the particulate phase of the aerosol to become available for delivery to the consumer.

Further, because the ventilated first tubular element can be configured to not substantially contribute to the overall RTD of the aerosol-generating article, in such an aerosol-generating articles the overall RTD of the article can advantageously be fine-tuned by adjusting the length and density of the first element comprising the aerosol-generating substrate or the length and optionally the length and density of a segment of filtration material forming part of the mouthpiece or the length and density of an element provided upstream of first element comprising the aerosol-generating substrate. Thus, aerosol-generating articles that have a predetermined RTD can be manufactured consistently and with great precision, such that satisfactory levels of RTD can be provided for the consumer even in the presence of ventilation.

Furthermore, the inventors have found that enhanced mixing of hot air from the aerosol-generating substrate with fresh air from the ventilation drawn through the ventilation holes may be achieved when providing ventilation into a tubular element having a folded end portion forming a first end wall at the first end of the tubular body, with the first end wall delimiting an opening for airflow between the cavity and the exterior of the tubular element. In particular, and without wishing to be bound by theory, it is thought that the combination of a partial airflow restriction created by the first end wall with the presence of incoming air from ventilation can be particularly effective promoting the mixing of hot air drawn through the aerosol-forming substrate with fresh air drawn through the ventilation holes.

The aerosol-generating article may further comprise an upstream section at a location upstream of the aerosol-generating substrate. The upstream section may comprise one or more upstream elements, such as a tubular element according to the invention. The upstream section may comprise an upstream element arranged immediately upstream of the rod of aerosol-generating substrate. The upstream element may be a tubular element according to the invention, such as the second tubular element described above.

The first element comprising the aerosol-generating substrate may further comprise a susceptor element located within the aerosol-generating substrate. The susceptor element may be an elongate susceptor element. The susceptor element may extend longitudinally within the aerosol-generating substrate. The susceptor element is configured to be in thermal contact with the aerosol-generating substrate.

As used herein, the term “susceptor element” refers to a material that can convert electromagnetic energy into heat. When located within a fluctuating electromagnetic field, eddy currents induced in the susceptor element cause heating of the susceptor element. As the elongate susceptor element is located in thermal contact with the aerosol-generating substrate, the aerosol-generating substrate is heated by the susceptor element.

When used for describing the susceptor element, the term “elongate” means that the susceptor element has a length dimension that is greater than its width dimension or its thickness dimension, for example greater than twice its width dimension or its thickness dimension.

The susceptor element is arranged substantially longitudinally within the rod. This means that the length dimension of the elongate susceptor element is arranged to be approximately parallel to the longitudinal direction of the rod, for example within plus or minus 10 degrees of parallel to the longitudinal direction of the rod. In preferred embodiments, the elongate susceptor element may be positioned in a radially central position within the rod, and extends along the longitudinal axis of the rod.

Preferably, the susceptor element extends all the way to a downstream end of the first element. The susceptor element may extend all the way to an upstream end of the first element. In particularly preferred embodiments, the susceptor element has substantially the same length as the first element, and extends from the upstream end of the first element to the downstream end of the first element.

The susceptor element is preferably in the form of a pin, rod, strip or blade.

The susceptor element preferably has a length from about 5 millimetres to about 15 millimetres, for example from about 6 millimetres to about 12 millimetres, or from about 8 millimetres to about 10 millimetres.

A ratio between the length of the susceptor element and the overall length of the aerosol-generating article substrate may be from about 0.2 to about 0.35.

Preferably, a ratio between the length of the susceptor element and the overall length of the aerosol-generating article substrate is at least about 0.22, more preferably at least about 0.24, even more preferably at least about 0.26. A ratio between the length of the susceptor element and the overall length of the aerosol-generating article substrate is preferably less than about 0.34, more preferably less than about 0.32, even more preferably less than about 0.3.

A ratio between the length of the susceptor element and the overall length of the aerosol-generating article substrate may be from about 0.22 to about 0.34, more preferably from about 0.24 to about 0.34, even more preferably from about 0.26 to about 0.34. A ratio between the length of the susceptor element and the overall length of the aerosol-generating article substrate may be from about 0.22 to about 0.32, more preferably from about 0.24 to about 0.32, even more preferably from about 0.26 to about 0.32. In further embodiments, a ratio between the length of the susceptor element and the overall length of the aerosol-generating article substrate is preferably from about 0.22 to about 0.3, more preferably from about 0.24 to about 0.3, even more preferably from about 0.26 to about 0.3.

In a particularly preferred embodiment, a ratio between the length of the susceptor element and the overall length of the aerosol-generating article substrate is about 0.27.

The susceptor element preferably has a width from about 1 millimetres to about 5 millimetres.

The susceptor element may generally have a thickness from about 0.01 millimetres to about 2 millimetres, for example from about 0.5 millimetres to about 2 millimetres. The susceptor element may have a thickness from about 10 micrometres to about 500 micrometres, more preferably from about 10 micrometres to about 100 micrometres.

If the susceptor element has a constant cross-section, for example a circular cross-section, it has a preferable width or diameter from about 1 millimetre to about 5 millimetres.

If the susceptor element has the form of a strip or blade, the strip or blade preferably has a rectangular shape having a width of preferably from about 2 millimetres to about 8 millimetres, more preferably from about 3 millimetres to about 5 millimetres. By way of example, a susceptor element in the form of a strip of blade may have a width of about 4 millimetres.

If the susceptor element has the form of a strip or blade, the strip or blade preferably has a rectangular shape and a thickness from about 0.03 millimetres to about 0.15 millimetres, more preferably from about 0.05 millimetres to about 0.09 millimetres. By way of example, a susceptor element in the form of a strip of blade may have a thickness of about 0.07 millimetres.

In a preferred embodiment, the elongate susceptor element is in the form of a strip or blade, preferably has a rectangular shape, and has a thickness from about 55 micrometres to about 65 micrometres.

More preferably, the elongate susceptor element has a thickness from about 57 micrometres to about 63 micrometres. Even more preferably, the elongate susceptor element has a thickness from about 58 micrometres to about 62 micrometres. In a particularly preferred embodiment, the elongate susceptor element has a thickness of about 60 micrometres.

Preferably, the elongate susceptor element has a length which is the same or shorter than the length of the aerosol-generating substrate. Preferably, the elongate susceptor element has a same length as the aerosol-generating substrate.

The susceptor element may be formed from any material that can be inductively heated to a temperature sufficient to generate an aerosol from the aerosol-generating substrate. Preferred susceptor elements comprise a metal or carbon.

A preferred susceptor element may comprise or consist of a ferromagnetic material, for example a ferromagnetic alloy, ferritic iron, or a ferromagnetic steel or stainless steel. A suitable susceptor element may be, or comprise, aluminium. Preferred susceptor elements may be formed from 400 series stainless steels, for example grade 410, or grade 420, or grade 430 stainless steel. Different materials will dissipate different amounts of energy when positioned within electromagnetic fields having similar values of frequency and field strength.

Thus, parameters of the susceptor element such as material type, length, width, and thickness may all be altered to provide a desired power dissipation within a known electromagnetic field. Preferred susceptor elements may be heated to a temperature in excess of 250 degrees Celsius.

Suitable susceptor elements may comprise a non-metallic core with a metal layer disposed on the non-metallic core, for example metallic tracks formed on a surface of a ceramic core. A susceptor element may have a protective external layer, for example a protective ceramic layer or protective glass layer encapsulating the susceptor element. The susceptor element may comprise a protective coating formed by a glass, a ceramic, or an inert metal, formed over a core of susceptor element material.

The susceptor element is arranged in thermal contact with the aerosol-generating substrate. Thus, when the susceptor element heats up the aerosol-generating substrate is heated up and an aerosol is formed. Preferably the susceptor element is arranged in direct physical contact with the aerosol-generating substrate, for example within the aerosol-generating substrate.

The susceptor element may be a multi-material susceptor element and may comprise a first susceptor element material and a second susceptor element material. The first susceptor element material is disposed in intimate physical contact with the second susceptor element material. The second susceptor element material preferably has a Curie temperature that is lower than 500 degrees Celsius. The first susceptor element material is preferably used primarily to heat the susceptor element when the susceptor element is placed in a fluctuating electromagnetic field. Any suitable material may be used. For example the first susceptor element material may be aluminium, or may be a ferrous material such as a stainless steel. The second susceptor element material is preferably used primarily to indicate when the susceptor element has reached a specific temperature, that temperature being the Curie temperature of the second susceptor element material. The Curie temperature of the second susceptor element material can be used to regulate the temperature of the entire susceptor element during operation. Thus, the Curie temperature of the second susceptor element material should be below the ignition point of the aerosol-generating substrate. Suitable materials for the second susceptor element material may include nickel and certain nickel alloys.

By providing a susceptor element having at least a first and a second susceptor element material, with either the second susceptor element material having a Curie temperature and the first susceptor element material not having a Curie temperature, or first and second susceptor element materials having first and second Curie temperatures distinct from one another, the heating of the aerosol-generating substrate and the temperature control of the heating may be separated. The first susceptor element material is preferably a magnetic material having a Curie temperature that is above 500 degrees Celsius. It is desirable from the point of view of heating efficiency that the Curie temperature of the first susceptor element material is above any maximum temperature that the susceptor element should be capable of being heated to. The second Curie temperature may preferably be selected to be lower than 400 degrees Celsius, preferably lower than 380 degrees Celsius, or lower than 360 degrees Celsius. It is preferable that the second susceptor element material is a magnetic material selected to have a second Curie temperature that is substantially the same as a desired maximum heating temperature. That is, it is preferable that the second Curie temperature is approximately the same as the temperature that the susceptor element should be heated to in order to generate an aerosol from the aerosol-generating substrate. The second Curie temperature may, for example, be within the range of 200 degrees Celsius to 400 degrees Celsius, or between 250 degrees Celsius and 360 degrees Celsius. The second Curie temperature of the second susceptor element material may, for example, be selected such that, upon being heated by a susceptor element that is at a temperature equal to the second Curie temperature, an overall average temperature of the aerosol-generating substrate does not exceed 240 degrees Celsius.

As defined above, the aerosol-generating article of the present invention comprises a rod of an aerosol-generating substrate. The aerosol-generating substrate may be a solid aerosol-generating substrate.

In certain preferred embodiments, the aerosol-generating substrate comprises homogenised plant material, preferably a homogenised tobacco material.

As used herein, the term “homogenised plant material” encompasses any plant material formed by the agglomeration of particles of plant. For example, sheets or webs of homogenised tobacco material for the aerosol-generating substrates of the present invention may be formed by agglomerating particles of tobacco material obtained by pulverising, grinding or comminuting plant material and optionally one or more of tobacco leaf lamina and tobacco leaf stems. The homogenised plant material may be produced by casting, extrusion, paper making processes or other any other suitable processes known in the art.

The homogenised plant material can be provided in any suitable form. For example, the homogenised plant material may be in the form of one or more sheets. As used herein, the term “sheet” describes a laminar element having a width and length substantially greater than the thickness thereof. The homogenised plant material may be in the form of a plurality of pellets or granules. The homogenised plant material may be in the form of a plurality of strands, strips or shreds. As used herein, the term “strand” describes an elongate element of material having a length that is substantially greater than the width and thickness thereof. The term “strand” should be considered to encompass strips, shreds and any other homogenised plant material having a similar form. The strands of homogenised plant material may be formed from a sheet of homogenised plant material, for example by cutting or shredding, or by other methods, for example, by an extrusion method.

The strands may be formed in situ within the aerosol-generating substrate as a result of the splitting or cracking of a sheet of homogenised plant material during formation of the aerosol-generating substrate, for example, as a result of crimping. The strands of homogenised plant material within the aerosol-generating substrate may be separate from each other. At least some strands of homogenised plant material within the aerosol-generating substrate may be at least partially connected to an adjacent strand or strands along the length of the strands. For example, adjacent strands may be connected by one or more fibres. This may occur, for example, where the strands have been formed due to the splitting of a sheet of homogenised plant material during production of the aerosol-generating substrate, as described above.

Preferably, the aerosol-generating substrate is in the form of one or more sheets of homogenised plant material. The one or more sheets of homogenised plant material may be produced by a casting process. The one or more sheets of homogenised plant material may be produced by a paper-making process. The one or more sheets as described herein may each individually have a thickness of between 100 micrometres and 600 micrometres, preferably between 150 micrometres and 300 micrometres, and most preferably between 200 micrometres and 250 micrometres. Individual thickness refers to the thickness of the individual sheet, whereas combined thickness refers to the total thickness of all sheets that make up the aerosol-generating substrate. For example, if the aerosol-generating substrate is formed from two individual sheets, then the combined thickness is the sum of the thickness of the two individual sheets or the measured thickness of the two sheets where the two sheets are stacked in the aerosol-generating substrate.

The one or more sheets as described herein may each individually have a grammage of between about 100 g/m² and about 300 g/m².

The one or more sheets as described herein may each individually have a density of from about 0.3 g/cm³ to about 1.3 g/cm³, and preferably from about 0.7 g/cm³ to about 1.0 g/cm³.

In embodiments in which the aerosol-generating substrate comprises one or more sheets of homogenised plant material, the sheets are preferably in the form of one or more gathered sheets. As used herein, the term “gathered” denotes that the sheet of homogenised plant material is convoluted, folded, or otherwise compressed or constricted substantially transversely to the cylindrical axis of a plug or a rod.

The one or more sheets of homogenised plant material may be gathered transversely relative to the longitudinal axis thereof and circumscribed with a wrapper to form a continuous rod or a plug.

The one or more sheets of homogenised plant material may advantageously be crimped or similarly treated. As used herein, the term “crimped” denotes a sheet having a plurality of substantially parallel ridges or corrugations. Alternatively or in addition to being crimped, the one or more sheets of homogenised plant material may be embossed, debossed, perforated or otherwise deformed to provide texture on one or both sides of the sheet.

Preferably, each sheet of homogenised plant material may be crimped such that it has a plurality of ridges or corrugations substantially parallel to the cylindrical axis of the plug. This treatment advantageously facilitates gathering of the crimped sheet of homogenised plant material to form the plug. Preferably, the one or more sheets of homogenised plant material may be gathered. It will be appreciated that crimped sheets of homogenised plant material may alternatively or in addition have a plurality of substantially parallel ridges or corrugations disposed at an acute or obtuse angle to the cylindrical axis of the plug. The sheet may be crimped to such an extent that the integrity of the sheet becomes disrupted at the plurality of parallel ridges or corrugations causing separation of the material, and results in the formation of shreds, strands or strips of homogenised plant material.

The one or more sheets of homogenised plant material may be cut into strands as referred to above. The aerosol-generating substrate may comprise a plurality of strands of the homogenised plant material. The strands may be used to form a plug. Typically, the width of such strands is about 5 millimetres, or about 4 millimetres, or about 3 millimetres, or about 2 millimetres or less. The length of the strands may be greater than about 5 millimetres, between about 5 millimetres to about 15 millimetres, about 8 millimetres to about 12 millimetres, or about 12 millimetres. Preferably, the strands have substantially the same length as each other. The length of the strands may be determined by the manufacturing process whereby a rod is cut into shorter plugs and the length of the strands corresponds to the length of the plug. The strands may be fragile which may result in breakage especially during transit. In such cases, the length of some of the strands may be less than the length of the plug.

The plurality of strands preferably extend substantially longitudinally along the length of the aerosol-generating substrate, aligned with the longitudinal axis. Preferably, the plurality of strands are therefore aligned substantially parallel to each other.

The homogenised plant material may comprise up to about 95 percent by weight of plant particles, on a dry weight basis. Preferably, the homogenised plant material comprises up to about 90 percent by weight of plant particles, more preferably up to about 80 percent by weight of plant particles, more preferably up to about 70 percent by weight of plant particles, more preferably up to about 60 percent by weight of plant particles, more preferably up to about 50 percent by weight of plant particles, on a dry weight basis.

For example, the homogenised plant material may comprise between about 2.5 percent and about 95 percent by weight of plant particles, or about 5 percent and about 90 percent by weight of plant particles, or between about 10 percent and about 80 percent by weight of plant particles, or between about 15 percent and about 70 percent by weight of plant particles, or between about 20 percent and about 60 percent by weight of plant particles, or between about 30 percent and about 50 percent by weight of plant particles, on a dry weight basis.

The homogenised plant material may be a homogenised tobacco material comprising tobacco particles. Sheets of homogenised tobacco material for use in such embodiments may have a tobacco content of at least about 40 percent by weight on a dry weight basis, more preferably of at least about 50 percent by weight on a dry weight basis more preferably at least about 70 percent by weight on a dry weight basis and most preferably at least about 90 percent by weight on a dry weight basis.

The term “tobacco particles” describes particles of any plant member of the genus Nicotiana. The term “tobacco particles” encompasses ground or powdered tobacco leaf lamina, ground or powdered tobacco leaf stems, tobacco dust, tobacco fines, and other particulate tobacco by-products formed during the treating, handling and shipping of tobacco. In a preferred embodiment, the tobacco particles are substantially all derived from tobacco leaf lamina. By contrast, isolated nicotine and nicotine salts are compounds derived from tobacco but are not considered tobacco particles for purposes of the invention and are not included in the percentage of particulate plant material.

The tobacco particles may be prepared from one or more varieties of tobacco plants. Any type of tobacco may be used in a blend. Examples of tobacco types that may be used include, but are not limited to, sun-cured tobacco, flue-cured tobacco, Burley tobacco, Maryland tobacco, Oriental tobacco, Virginia tobacco, and other specialty tobaccos.

Flue-curing is a method of curing tobacco, which is particularly used with Virginia tobaccos. During the flue-curing process, heated air is circulated through densely packed tobacco. During a first stage, the tobacco leaves turn yellow and wilt. During a second stage, the laminae of the leaves are completely dried. During a third stage, the leaf stems are completely dried.

Burley tobacco plays a significant role in many tobacco blends. Burley tobacco has a distinctive flavour and aroma and also has an ability to absorb large amounts of casing.

Oriental is a type of tobacco which has small leaves, and high aromatic qualities. However, Oriental tobacco has a milder flavour than, for example, Burley. Generally, therefore, Oriental tobacco is used in relatively small proportions in tobacco blends.

Kasturi, Madura and Jatim are subtypes of sun-cured tobacco that can be used. Preferably, Kasturi tobacco and flue-cured tobacco may be used in a blend to produce the tobacco particles. Accordingly, the tobacco particles in the particulate plant material may comprise a blend of Kasturi tobacco and flue-cured tobacco.

The tobacco particles may have a nicotine content of at least about 2.5 percent by weight, based on dry weight. More preferably, the tobacco particles may have a nicotine content of at least about 3 percent, even more preferably at least about 3.2 percent, even more preferably at least about 3.5 percent, most preferably at least about 4 percent by weight, based on dry weight.

The homogenised plant material may comprise tobacco particles in combination with non-tobacco plant flavour particles. Preferably, the non-tobacco plant flavour particles are selected from one or more of: ginger particles, rosemary particles, eucalyptus particles, clove particles and star anise particles. Preferably, in such embodiments, the homogenised plant material comprises at least about 2.5 percent by weight of the non-tobacco plant flavour particles, on a dry weight basis, with the remainder of the plant particles being tobacco particles. Preferably, the homogenised plant material comprises at least about 4 percent by weight of non-tobacco plant flavour particles, more preferably at least about 6 percent by weight of non-tobacco plant flavour particles, more preferably at least about 8 percent by weight of non-tobacco plant flavour particles and more preferably at least about 10 percent by weight of non-tobacco plant flavour particles, on a dry weight basis. Preferably, the homogenised plant material comprises up to about 20 percent by weight of non-tobacco plant flavour particles, more preferably up to about 18 percent by weight of non-tobacco plant flavour particles, more preferably up to about 16 percent by weight of non-tobacco plant flavour particles.

The weight ratio of the non-tobacco plant flavour particles and the tobacco particles in the particulate plant material forming the homogenised plant material may vary depending on the desired flavour characteristics and composition of the aerosol produced from the aerosol-generating substrate during use. Preferably, the homogenised plant material comprises at least a 1:30 weight ratio of non-tobacco plant flavour particles to tobacco particles, more preferably at least a 1:20 weight ratio of non-tobacco plant flavour particles to tobacco particles, more preferably at least a 1:10 weight ratio of non-tobacco plant flavour particles to tobacco particles and most preferably at least a 1:5 weight ratio of non-tobacco plant flavour particles to tobacco particles, on a dry weight basis.

The homogenised plant material may comprise cannabis particles. The term “cannabis particles” refers to particles of a cannabis plant, such as the species Cannabis sativa, Cannabis indica, and Cannabis ruderalis.

The homogenised plant material preferably comprises no more than 95 percent by weight of the particulate plant material, on a dry weight basis. The particulate plant material is therefore typically combined with one or more other components to form the homogenised plant material.

The homogenised plant material may further comprise a binder to alter the mechanical properties of the particulate plant material, wherein the binder is included in the homogenised plant material during manufacturing as described herein. Suitable exogenous binders would be known to the skilled person and include but are not limited to: gums such as, for example, guar gum, xanthan gum, arabic gum and locust bean gum; cellulosic binders such as, for example, hydroxypropyl cellulose, carboxymethyl cellulose, hydroxyethyl cellulose, methyl cellulose and ethyl cellulose; polysaccharides such as, for example, starches, organic acids, such as alginic acid, conjugate base salts of organic acids, such as sodium-alginate, agar and pectins; and combinations thereof. Preferably, the binder comprises guar gum.

The binder may be present in an amount of from about 1 percent to about 10 percent by weight, based on the dry weight of the homogenised plant material, preferably in an amount of from about 2 percent to about 5 percent by weight, based on the dry weight of the homogenised plant material.

The homogenised plant material may further comprise one or more lipids to facilitate the diffusivity of volatile components (for example, aerosol formers, gingerols and nicotine), wherein the lipid is included in the homogenised plant material during manufacturing as described herein. Suitable lipids for inclusion in the homogenised plant material include, but are not limited to: medium-chain triglycerides, cocoa butter, palm oil, palm kernel oil, mango oil, shea butter, soybean oil, cottonseed oil, coconut oil, hydrogenated coconut oil, candelilla wax, carnauba wax, shellac, sunflower wax, sunflower oil, rice bran, and Revel A; and combinations thereof.

The homogenised plant material may further comprise a pH modifier.

The homogenised plant material may further comprise fibres to alter the mechanical properties of the homogenised plant material, wherein the fibres are included in the homogenised plant material during manufacturing as described herein. Suitable exogenous fibres for inclusion in the homogenised plant material are known in the art and include fibres formed from non-tobacco material and non-ginger material, including but not limited to: cellulose fibres; soft-wood fibres; hard-wood fibres; jute fibres and combinations thereof. Exogenous fibres derived from tobacco and/or ginger can also be added. Any fibres added to the homogenised plant material are not considered to form part of the “particulate plant material” as defined above. Prior to inclusion in the homogenised plant material, fibres may be treated by suitable processes known in the art including, but not limited to: mechanical pulping; refining; chemical pulping; bleaching; sulfate pulping; and combinations thereof. A fibre typically has a length greater than its width.

Suitable fibres typically have lengths of greater than 400 micrometres and less than or equal to 4 millimetres, preferably within the range of 0.7 millimetres to 4 millimetres. Preferably, the fibres are present in an amount of about 2 percent to about 15 percent by weight, most preferably at about 4 percent by weight, based on the dry weight of the substrate.

The homogenised plant material may further comprise one or more aerosol formers. Upon volatilisation, an aerosol former can convey other vaporised compounds released from the aerosol-generating substrate upon heating, such as nicotine and flavourants, in an aerosol. Suitable aerosol formers for inclusion in the homogenised plant material are known in the art and include, but are not limited to: polyhydric alcohols, such as triethylene glycol, propylene glycol, 1,3-butanediol and glycerol; esters of polyhydric alcohols, such as glycerol mono-, di- or triacetate; and aliphatic esters of mono-, di- or polycarboxylic acids, such as dimethyl dodecanedioate and dimethyl tetradecanedioate.

The homogenised plant material may have an aerosol former content of between about 5 percent and about 30 percent by weight on a dry weight basis, such as between about 10 percent and about 25 percent by weight on a dry weight basis, or between about 15 percent and about 20 percent by weight on a dry weight basis.

For example, if the substrate is intended for use in an aerosol-generating article for an electrically-operated aerosol-generating system having a heating element, it may preferably include an aerosol former content of between about 5 percent to about 30 percent by weight on a dry weight basis. If the substrate is intended for use in an aerosol-generating article for an electrically-operated aerosol-generating system having a heating element, the aerosol former is preferably glycerol.

The homogenised plant material may have an aerosol former content of about 1 percent to about 5 percent by weight on a dry weight basis. For example, if the substrate is intended for use in an aerosol-generating article in which aerosol former is kept in a reservoir separate from the substrate, the substrate may have an aerosol former content of greater than 1 percent and less than about 5 percent. In such embodiments, the aerosol former is volatilised upon heating and a stream of the aerosol former is contacted with the aerosol-generating substrate so as to entrain the flavours from the aerosol-generating substrate in the aerosol.

The homogenised plant material may have an aerosol former content of about 30 percent by weight to about 45 percent by weight. This relatively high level of aerosol former is particularly suitable for aerosol-generating substrates that are intended to be heated at a temperature of less than 275 degrees Celsius. In such embodiments, the homogenised plant material preferably further comprises between about 2 percent by weight and about 10 percent by weight of cellulose ether, on a dry weight basis and between about 5 percent by weight and about 50 percent by weight of additional cellulose, on a dry weight basis. The use of the combination of cellulose ether and additional cellulose has been found to provide a particularly effective delivery of aerosol when used in an aerosol-generating substrate having an aerosol former content of between 30 percent by weight and 45 percent by weight.

Suitable cellulose ethers include but are not limited to methyl cellulose, hydroxypropyl methyl cellulose, ethyl cellulose, hydroxyl ethyl cellulose, hydroxyl propyl cellulose, ethyl hydroxyl ethyl cellulose and carboxymethyl cellulose (CMC). In particularly preferred embodiments, the cellulose ether is carboxymethyl cellulose.

As used herein, the term “additional cellulose” encompasses any cellulosic material incorporated into the homogenised plant material which does not derive from the non-tobacco plant particles or tobacco particles provided in the homogenised plant material. The additional cellulose is therefore incorporated in the homogenised plant material in addition to the non-tobacco plant material or tobacco material, as a separate and distinct source of cellulose to any cellulose intrinsically provided within the non-tobacco plant particles or tobacco particles. The additional cellulose will typically derive from a different plant to the non-tobacco plant particles or tobacco particles. Preferably, the additional cellulose is in the form of an inert cellulosic material, which is sensorially inert and therefore does not substantially impact the organoleptic characteristics of the aerosol generated from the aerosol-generating substrate. For example, the additional cellulose is preferably a tasteless and odourless material.

The additional cellulose may comprise cellulose powder, cellulose fibres, or a combination thereof.

The aerosol former may act as a humectant in the aerosol-generating substrate.

The wrapper circumscribing the rod of homogenised plant material may be a paper wrapper or a non-paper wrapper. Suitable paper wrappers for use in specific embodiments of the invention are known in the art and include, but are not limited to: cigarette papers; and filter plug wraps. Suitable non-paper wrappers for use in specific embodiments of the invention are known in the art and include, but are not limited to sheets of homogenised tobacco materials. In certain preferred embodiments, the wrapper may be formed of a laminate material comprising a plurality of layers. Preferably, the wrapper is formed of an aluminium co-laminated sheet. The use of a co-laminated sheet comprising aluminium advantageously prevents combustion of the aerosol-generating substrate in the event that the aerosol-generating substrate should be ignited, rather than heated in the intended manner.

In some preferred embodiments, the aerosol-generating substrate comprises a gel composition that includes an alkaloid compound, or a cannabinoid compound, or both an alkaloid compound and a cannabinoid compound. In particularly preferred embodiments, the aerosol-generating substrate comprises a gel composition that includes nicotine.

Preferably, the gel composition comprises an alkaloid compound, or a cannabinoid compound, or both an alkaloid compound and a cannabinoid compound; an aerosol former; and at least one gelling agent. Preferably, the at least one gelling agent forms a solid medium and the glycerol is dispersed in the solid medium, with the alkaloid or cannabinoid dispersed in the glycerol. Preferably, the gel composition is a stable gel phase.

Advantageously, a stable gel composition comprising nicotine provides predictable composition form upon storage or transit from manufacture to the consumer. The stable gel composition comprising nicotine substantially maintains its shape. The stable gel composition comprising nicotine substantially does not release a liquid phase upon storage or transit from manufacture to the consumer. The stable gel composition comprising nicotine may provide for a simple consumable design. This consumable may not have to be designed to contain a liquid, thus a wider range of materials and container constructions may be contemplated.

The gel composition described herein may be combined with an aerosol-generating device to provide a nicotine aerosol to the lungs at inhalation or air flow rates that are within conventional smoking regime inhalation or air flow rates. The aerosol-generating device may continuously heat the gel composition. A consumer may take a plurality of inhalations or “puffs” where each “puff” delivers an amount of nicotine aerosol. The gel composition may be capable of delivering a high nicotine/low total particulate matter (TPM) aerosol to a consumer when heated, preferably in a continuous manner.

The phrase “stable gel phase” or “stable gel” refers to gel that substantially maintains its shape and mass when exposed to a variety of environmental conditions. The stable gel may not substantially release (sweat) or absorb water when exposed to a standard temperature and pressure while varying relative humidity from about 10 percent to about 60 percent. For example, the stable gel may substantially maintain its shape and mass when exposed to a standard temperature and pressure while varying relative humidity from about 10 percent to about 60 percent.

The gel composition may include an alkaloid compound, or a cannabinoid compound, or both an alkaloid compound and a cannabinoid compound. The gel composition may include one or more alkaloids. The gel composition may include one or more cannabinoids. The gel composition may include a combination of one or more alkaloids and one or more cannabinoids.

The term “alkaloid compound” refers to any one of a class of naturally occurring organic compounds that contain one or more basic nitrogen atoms. Generally, an alkaloid contains at least one nitrogen atom in an amine-type structure. This or another nitrogen atom in the molecule of the alkaloid compound can be active as a base in acid-base reactions. Most alkaloid compounds have one or more of their nitrogen atoms as part of a cyclic system, such as for example a heterocylic ring. In nature, alkaloid compounds are found primarily in plants, and are especially common in certain families of flowering plants. However, some alkaloid compounds are found in animal species and fungi. In this disclosure, the term “alkaloid compound” refers to both naturally derived alkaloid compounds and synthetically manufactured alkaloid compounds.

The gel composition may preferably include an alkaloid compound selected from the group consisting of nicotine, anatabine, and combinations thereof.

Preferably the gel composition includes nicotine.

The term “nicotine” refers to nicotine and nicotine derivatives such as free-base nicotine, nicotine salts and the like.

The term “cannabinoid compound” refers to any one of a class of naturally occurring compounds that are found in parts of the cannabis plant—namely the species Cannabis sativa, Cannabis indica, and Cannabis ruderalis. Cannabinoid compounds are especially concentrated in the female flower heads. Cannabinoid compounds naturally occurring in the cannabis plant include cannabidiol (CBD) and tetrahydrocannabinol (THC). In this disclosure, the term “cannabinoid compounds” is used to describe both naturally derived cannabinoid compounds and synthetically manufactured cannabinoid compounds.

The gel may include a cannabinoid compound selected from the group consisting of cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabielsoin (CBE), cannabicitran (CBT), and combinations thereof.

The gel composition may preferably include a cannabinoid compound selected from the group consisting of cannabidiol (CBD), THC (tetrahydrocannabinol) and combinations thereof.

The gel may preferably include cannabidiol (CBD).

The gel composition may include nicotine and cannabidiol (CBD).

The gel composition may include nicotine, cannabidiol (CBD), and THC (tetrahydrocannabinol).

The gel composition preferably includes about 0.5 percent by weight to about 10 percent by weight of an alkaloid compound, or about 0.5 percent by weight to about 10 percent by weight of a cannabinoid compound, or both an alkaloid compound and a cannabinoid compound in a total amount from about 0.5 percent by weight to about 10 percent by weight. The gel composition may include about 0.5 percent by weight to about 5 percent by weight of an alkaloid compound, or about 0.5 percent by weight to about 5 percent by weight of a cannabinoid compound, or both an alkaloid compound and a cannabinoid compound in a total amount from about 0.5 percent by weight to about 5 percent by weight. Preferably the gel composition includes about 1 percent by weight to about 3 percent by weight of an alkaloid compound, or about 1 percent by weight to about 3 percent by weight of a cannabinoid compound, or both an alkaloid compound and a cannabinoid compound in a total amount from about 1 percent by weight to about 3 percent by weight. The gel composition may preferably include about 1.5 percent by weight to about 2.5 percent by weight of an alkaloid compound, or about 1.5 percent by weight to about 2.5 percent by weight of a cannabinoid compound, or both an alkaloid compound and a cannabinoid compound in a total amount from about 1.5 percent by weight to about 2.5 percent by weight. The gel composition may preferably include about 2 percent by weight of an alkaloid compound, or about 2 percent by weight of a cannabinoid compound, or both an alkaloid compound and a cannabinoid compound in a total amount of about 2 percent by weight. The alkaloid compound component of the gel formulation may be the most volatile component of the gel formulation. In some aspects water may be the most volatile component of the gel formulation and the alkaloid compound component of the gel formulation may be the second most volatile component of the gel formulation. The cannabinoid compound component of the gel formulation may be the most volatile component of the gel formulation. In some aspects water may be the most volatile component of the gel formulation and the alkaloid compound component of the gel formulation may be the second most volatile component of the gel formulation.

Preferably nicotine is included in the gel compositions. The nicotine may be added to the composition in a free base form or a salt form. The gel composition includes about 0.5 percent by weight to about 10 percent by weight nicotine, or about 0.5 percent by weight to about 5 percent by weight nicotine. Preferably the gel composition includes about 1 percent by weight to about 3 percent by weight nicotine, or about 1.5 percent by weight to about 2.5 percent by weight nicotine, or about 2 percent by weight nicotine. The nicotine component of the gel formulation may be the most volatile component of the gel formulation. In some aspects water may be the most volatile component of the gel formulation and the nicotine component of the gel formulation may be the second most volatile component of the gel formulation.

The gel composition preferably includes an aerosol-former. Ideally the aerosol-former is substantially resistant to thermal degradation at the operating temperature of the associated aerosol-generating device. Suitable aerosol-formers include, but are not limited to: polyhydric alcohols, such as triethylene glycol, 1, 3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Polyhydric alcohols or mixtures thereof, may be one or more of triethylene glycol, 1, 3-butanediol and, glycerine (glycerol or propane-1,2,3-triol) or polyethylene glycol. The aerosol-former is preferably glycerol.

The gel composition may include a majority of an aerosol-former. The gel composition may include a mixture of water and the aerosol-former where the aerosol-former forms a majority (by weight) of the gel composition. The aerosol-former may form at least about 50 percent by weight of the gel composition. The aerosol-former may form at least about 60 percent by weight or at least about 65 percent by weight or at least about 70 percent by weight of the gel composition. The aerosol-former may form about 70 percent by weight to about 80 percent by weight of the gel composition. The aerosol-former may form about 70 percent by weight to about 75 percent by weight of the gel composition.

The gel composition may include a majority of glycerol. The gel composition may include a mixture of water and the glycerol where the glycerol forms a majority (by weight) of the gel composition. The glycerol may form at least about 50 percent by weight of the gel composition. The glycerol may form at least about 60 percent by weight or at least about 65 percent by weight or at least about 70 percent by weight of the gel composition. The glycerol may form about 70 percent by weight to about 80 percent by weight of the gel composition. The glycerol may form about 70 percent by weight to about 75 percent by weight of the gel composition.

The gel composition preferably includes at least one gelling agent. Preferably, the gel composition includes a total amount of gelling agents in a range from about 0.4 percent by weight to about 10 percent by weight. More preferably, the composition includes the gelling agents in a range from about 0.5 percent by weight to about 8 percent by weight. More preferably, the composition includes the gelling agents in a range from about 1 percent by weight to about 6 percent by weight. More preferably, the composition includes the gelling agents in a range from about 2 percent by weight to about 4 percent by weight. More preferably, the composition includes the gelling agents in a range from about 2 percent by weight to about 3 percent by weight.

The term “gelling agent” refers to a compound that homogeneously, when added to a 50 percent by weight water/50 percent by weight glycerol mixture, in an amount of about 0.3 percent by weight, forms a solid medium or support matrix leading to a gel. Gelling agents include, but are not limited to, hydrogen-bond crosslinking gelling agents, and ionic crosslinking gelling agents.

The gelling agent may include one or more biopolymers. The biopolymers may be formed of polysaccharides.

Biopolymers include, for example, gellan gums (native, low acyl gellan gum, high acyl gellan gums with low acyl gellan gum being preferred), xanthan gum, alginates (alginic acid), agar, guar gum, and the like. The composition may preferably include xanthan gum. The composition may include two biopolymers. The composition may include three biopolymers. The composition may include the two biopolymers in substantially equal weights. The composition may include the three biopolymers in substantially equal weights.

Preferably, the gel composition comprises at least about 0.2 percent by weight hydrogen-bond crosslinking gelling agent. The gel composition preferably comprises at least about 0.2 percent by weight ionic crosslinking gelling agent. Most preferably, the gel composition comprises at least about 0.2 percent by weight hydrogen-bond crosslinking gelling agent and at least about 0.2 percent by weight ionic crosslinking gelling agent. The gel composition may comprise about 0.5 percent by weight to about 3 percent by weight hydrogen-bond crosslinking gelling agent and about 0.5 percent by weight to about 3 percent by weight ionic crosslinking gelling agent, or about 1 percent by weight to about 2 percent by weight hydrogen-bond crosslinking gelling agent and about 1 percent by weight to about 2 percent by weight ionic crosslinking gelling agent. The hydrogen-bond crosslinking gelling agent and ionic crosslinking gelling agent may be present in the gel composition in substantially equal amounts by weight.

The term “hydrogen-bond crosslinking gelling agent” refers to a gelling agent that forms non-covalent crosslinking bonds or physical crosslinking bonds via hydrogen bonding. Hydrogen bonding is a type of electrostatic dipole-dipole attraction between molecules, not a covalent bond to a hydrogen atom. It results from the attractive force between a hydrogen atom covalently bonded to a very electronegative atom such as a N, 0, or F atom and another very electronegative atom.

The hydrogen-bond crosslinking gelling agent may include one or more of a galactomannan, gelatin, agarose, or konjac gum, or agar. The hydrogen-bond crosslinking gelling agent may preferably include agar.

The gel composition preferably includes the hydrogen-bond crosslinking gelling agent in a range from about 0.3 percent by weight to about 5 percent by weight. Preferably the composition includes the hydrogen-bond crosslinking gelling agent in a range from about 0.5 percent by weight to about 3 percent by weight. Preferably the composition includes the hydrogen-bond crosslinking gelling agent in a range from about 1 percent by weight to about 2 percent by weight.

The gel composition may include a galactomannan in a range from about 0.2 percent by weight to about 5 percent by weight. Preferably the galactomannan may be in a range from about 0.5 percent by weight to about 3 percent by weight. Preferably the galactomannan may be in a range from about 0.5 percent by weight to about 2 percent by weight. Preferably the galactomannan may be in a range from about 1 percent by weight to about 2 percent by weight.

The gel composition may include a gelatin in a range from about 0.2 percent by weight to about 5 percent by weight. Preferably the gelatin may be in a range from about 0.5 percent by weight to about 3 percent by weight. Preferably the gelatin may be in a range from about 0.5 percent by weight to about 2 percent by weight. Preferably the gelatin may be in a range from about 1 percent by weight to about 2 percent by weight.

The gel composition may include agarose in a range from about 0.2 percent by weight to about 5 percent by weight. Preferably the agarose may be in a range from about 0.5 percent by weight to about 3 percent by weight. Preferably the agarose may be in a range from about 0.5 percent by weight to about 2 percent by weight. Preferably the agarose may be in a range from about 1 percent by weight to about 2 percent by weight.

The gel composition may include konjac gum in a range from about 0.2 percent by weight to about 5 percent by weight. Preferably the konjac gum may be in a range from about 0.5 percent by weight to about 3 percent by weight. Preferably the konjac gum may be in a range from about 0.5 percent by weight to about 2 percent by weight. Preferably the konjac gum may be in a range from about 1 percent by weight to about 2 percent by weight.

The gel composition may include agar in a range from about 0.2 percent by weight to about 5 percent by weight. Preferably the agar may be in a range from about 0.5 percent by weight to about 3 percent by weight. Preferably the agar may be in a range from about 0.5 percent by weight to about 2 percent by weight. Preferably the agar may be in a range from about 1 percent by weight to about 2 percent by weight.

The term “ionic crosslinking gelling agent” refers to a gelling agent that forms non-covalent crosslinking bonds or physical crosslinking bonds via ionic bonding. Ionic crosslinking involves the association of polymer chains by noncovalent interactions. A crosslinked network is formed when multivalent molecules of opposite charges electrostatically attract each other giving rise to a crosslinked polymeric network.

The ionic crosslinking gelling agent may include low acyl gellan, pectin, kappa carrageenan, iota carrageenan or alginate. The ionic crosslinking gelling agent may preferably include low acyl gellan.

The gel composition may include the ionic crosslinking gelling agent in a range from about 0.3 percent by weight to about 5 percent by weight. Preferably the composition includes the ionic crosslinking gelling agent in a range from about 0.5 percent by weight to about 3 percent by weight by weight. Preferably the composition includes the ionic crosslinking gelling agent in a range from about 1 percent by weight to about 2 percent by weight.

The gel composition may include low acyl gellan in a range from about 0.2 percent by weight to about 5 percent by weight. Preferably the low acyl gellan may be in a range from about 0.5 percent by weight to about 3 percent by weight. Preferably the low acyl gellan may be in a range from about 0.5 percent by weight to about 2 percent by weight. Preferably the low acyl gellan may be in a range from about 1 percent by weight to about 2 percent by weight.

The gel composition may include pectin in a range from about 0.2 percent by weight to about 5 percent by weight. Preferably the pectin may be in a range from about 0.5 percent by weight to about 3 percent by weight. Preferably the pectin may be in a range from about 0.5 percent by weight to about 2 percent by weight. Preferably the pectin may be in a range from about 1 percent by weight to about 2 percent by weight.

The gel composition may include kappa carrageenan in a range from about 0.2 percent by weight to about 5 percent by weight. Preferably the kappa carrageenan may be in a range from about 0.5 percent by weight to about 3 percent by weight. Preferably the kappa carrageenan may be in a range from about 0.5 percent by weight to about 2 percent by weight. Preferably the kappa carrageenan may be in a range from about 1 percent by weight to about 2 percent by weight.

The gel composition may include iota carrageenan in a range from about 0.2 percent by weight to about 5 percent by weight. Preferably the iota carrageenan may be in a range from about 0.5 percent by weight to about 3 percent by weight. Preferably the iota carrageenan may be in a range from about 0.5 percent by weight to about 2 percent by weight. Preferably the iota carrageenan may be in a range from about 1 percent by weight to about 2 percent by weight.

The gel composition may include alginate in a range from about 0.2 percent by weight to about 5 percent by weight. Preferably the alginate may be in a range from about 0.5 percent by weight to about 3 percent by weight. Preferably the alginate may be in a range from about 0.5 percent by weight to about 2 percent by weight. Preferably the alginate may be in a range from about 1 percent by weight to about 2 percent by weight.

The gel composition may include the hydrogen-bond crosslinking gelling agent and ionic crosslinking gelling agent in a ratio of about 3:1 to about 1:3. Preferably the gel composition may include the hydrogen-bond crosslinking gelling agent and ionic crosslinking gelling agent in a ratio of about 2:1 to about 1:2. Preferably the gel composition may include the hydrogen-bond crosslinking gelling agent and ionic crosslinking gelling agent in a ratio of about 1:1.

The gel composition may further include a viscosifying agent. The viscosifying agent combined with the hydrogen-bond crosslinking gelling agent and the ionic crosslinking gelling agent appears to surprisingly support the solid medium and maintain the gel composition even when the gel composition comprises a high level of glycerol.

The term “viscosifying agent” refers to a compound that, when added homogeneously into a 25 degrees Celsius, 50 percent by weight water/50 percent by weight glycerol mixture, in an amount of 0.3 percent by weight, increases the viscosity without leading to the formation of a gel, the mixture staying or remaining fluid. Preferably the viscosifying agent refers to a compound that when added homogeneously into a 25 degrees Celsius 50 percent by weight water/50 percent by weight glycerol mixture, in an amount of 0.3 percent by weight, increases the viscosity to at least 50 cPs, preferably at least 200 cPs, preferably at least 500 cPs, preferably at least 1000 cPs at a shear rate of 0.1 s⁻¹, without leading to the formation of a gel, the mixture staying or remaining fluid. Preferably the viscosifying agent refers to a compound that when added homogeneously into a 25 degrees Celsius 50 percent by weight water/50 percent by weight glycerol mixture, in an amount of 0.3 percent by weight, increases the viscosity at least 2 times, or at least 5 times, or at least 10 times, or at least 100 times higher than before addition, at a shear rate of 0.1 s⁻¹, without leading to the formation of a gel, the mixture staying or remaining fluid.

The viscosity values recited herein can be measured using a Brookfield RVT viscometer rotating a disc type RV #2 spindle at 25 degrees Celsius at a speed of 6 revolutions per minute (rpm).

The gel composition preferably includes the viscosifying agent in a range from about 0.2 percent by weight to about 5 percent by weight. Preferably the composition includes the viscosifying agent in a range from about 0.5 percent by weight to about 3 percent by weight. Preferably the composition includes the viscosifying agent in a range from about 0.5 percent by weight to about 2 percent by weight. Preferably the composition includes the viscosifying agent in a range from about 1 percent by weight to about 2 percent by weight.

The viscosifying agent may include one or more of xanthan gum, carboxymethyl-cellulose, microcrystalline cellulose, methyl cellulose, gum Arabic, guar gum, lambda carrageenan, or starch. The viscosifying agent may preferably include xanthan gum.

The gel composition may include xanthan gum in a range from about 0.2 percent by weight to about 5 percent by weight. Preferably the xanthan gum may be in a range from about 0.5 percent by weight to about 3 percent by weight. Preferably the xanthan gum may be in a range from about 0.5 percent by weight to about 2 percent by weight. Preferably the xanthan gum may be in a range from about 1 percent by weight to about 2 percent by weight.

The gel composition may include carboxymethyl-cellulose in a range from about 0.2 percent by weight to about 5 percent by weight. Preferably the carboxymethyl-cellulose may be in a range from about 0.5 percent by weight to about 3 percent by weight. Preferably the carboxymethyl-cellulose may be in a range from about 0.5 percent by weight to about 2 percent by weight. Preferably the carboxymethyl-cellulose may be in a range from about 1 percent by weight to about 2 percent by weight.

The gel composition may include microcrystalline cellulose in a range from about 0.2 percent by weight to about 5 percent by weight. Preferably the microcrystalline cellulose may be in a range from about 0.5 percent by weight to about 3 percent by weight. Preferably the microcrystalline cellulose may be in a range from about 0.5 percent by weight to about 2 percent by weight. Preferably the microcrystalline cellulose may be in a range from about 1 percent by weight to about 2 percent by weight.

The gel composition may include methyl cellulose in a range from about 0.2 percent by weight to about 5 percent by weight. Preferably the methyl cellulose may be in a range from about 0.5 percent by weight to about 3 percent by weight. Preferably the methyl cellulose may be in a range from about 0.5 percent by weight to about 2 percent by weight. Preferably the methyl cellulose may be in a range from about 1 percent by weight to about 2 percent by weight.

The gel composition may include gum Arabic in a range from about 0.2 percent by weight to about 5 percent by weight. Preferably the gum Arabic may be in a range from about 0.5 percent by weight to about 3 percent by weight. Preferably the gum Arabic may be in a range from about 0.5 percent by weight to about 2 percent by weight. Preferably the gum Arabic may be in a range from about 1 percent by weight to about 2 percent by weight.

The gel composition may include guar gum in a range from about 0.2 percent by weight to about 5 percent by weight. Preferably the guar gum may be in a range from about 0.5 percent by weight to about 3 percent by weight. Preferably the guar gum may be in a range from about 0.5 percent by weight to about 2 percent by weight. Preferably the guar gum may be in a range from about 1 percent by weight to about 2 percent by weight.

The gel composition may include lambda carrageenan in a range from about 0.2 percent by weight to about 5 percent by weight. Preferably the lambda carrageenan may be in a range from about 0.5 percent by weight to about 3 percent by weight. Preferably the lambda carrageenan may be in a range from about 0.5 percent by weight to about 2 percent by weight. Preferably the lambda carrageenan may be in a range from about 1 percent by weight to about 2 percent by weight.

The gel composition may include starch in a range from about 0.2 percent by weight to about 5 percent by weight. Preferably the starch may be in a range from about 0.5 percent by weight to about 3 percent by weight. Preferably the starch may be in a range from about 0.5 percent by weight to about 2 percent by weight. Preferably the starch may be in a range from about 1 percent by weight to about 2 percent by weight.

The gel composition may further include a divalent cation. Preferably the divalent cation includes calcium ions, such as calcium lactate in solution. Divalent cations (such as calcium ions) may assist in the gel formation of compositions that include gelling agents such as the ionic crosslinking gelling agent, for example. The ion effect may assist in the gel formation. The divalent cation may be present in the gel composition in a range from about 0.1 to about 1 percent by weight, or about 0.5 percent by weight t.

The gel composition may further include an acid. The acid may comprise a carboxylic acid. The carboxylic acid may include a ketone group. Preferably the carboxylic acid may include a ketone group having less than about 10 carbon atoms, or less than about 6 carbon atoms or less than about 4 carbon atoms, such as levulinic acid or lactic acid. Preferably this carboxylic acid has three carbon atoms (such as lactic acid). Lactic acid surprisingly improves the stability of the gel composition even over similar carboxylic acids. The carboxylic acid may assist in the gel formation. The carboxylic acid may reduce variation of the alkaloid compound concentration, or the cannabinoid compound concentration, or both the alkaloid compound concentration and the cannabinoid compound within the gel composition during storage. The carboxylic acid may reduce variation of the nicotine concentration within the gel composition during storage.

The gel composition may include a carboxylic acid in a range from about 0.1 percent by weight to about 5 percent by weight. Preferably the carboxylic acid may be in a range from about 0.5 percent by weight to about 3 percent by weight. Preferably the carboxylic acid may be in a range from about 0.5 percent by weight to about 2 percent by weight. Preferably the carboxylic acid may be in a range from about 1 percent by weight to about 2 percent by weight.

The gel composition may include lactic acid in a range from about 0.1 percent by weight to about 5 percent by weight. Preferably the lactic acid may be in a range from about 0.5 percent by weight to about 3 percent by weight. Preferably the lactic acid may be in a range from about 0.5 percent by weight to about 2 percent by weight. Preferably the lactic acid may be in a range from about 1 percent by weight to about 2 percent by weight.

The gel composition may include levulinic acid in a range from about 0.1 percent by weight to about 5 percent by weight. Preferably the levulinic acid may be in a range from about 0.5 percent by weight to about 3 percent by weight. Preferably the levulinic acid may be in a range from about 0.5 percent by weight to about 2 percent by weight. Preferably the levulinic acid may be in a range from about 1 percent by weight to about 2 percent by weight.

The gel composition preferably comprises some water. The gel composition is more stable when the composition comprises some water. Preferably the gel composition comprises at least about 1 percent by weight, or at least about 2 percent by weight, or at least about 5 percent by weight of water. Preferably the gel composition comprises at least about 10 percent by weight or at least about 15 percent by weight water.

Preferably the gel composition comprises between about 8 percent by weight to about 32 percent by weight water. Preferably the gel composition comprises from about 15 percent by weight to about 25 percent by weight water. Preferably the gel composition comprises from about 18 percent by weight to about 22 percent by weight water. Preferably the gel composition comprises about 20 percent by weight water.

Preferably, the aerosol-generating substrate comprises between about 150 mg and about 350 mg of the gel composition.

Preferably, in embodiments comprising a gel composition, the aerosol-generating substrate comprises a porous medium loaded with the gel composition. Advantages of a porous medium loaded with the gel composition is that the gel composition is retained within the porous medium, and this may aid manufacturing, storage or transport of the gel composition. It may assist in keeping the desired shape of the gel composition, especially during manufacture, transport, or use.

The term “porous” is used herein to refer to a material that provides a plurality of pores or openings that allow the passage of air through the material.

The porous medium may be any suitable porous material able to hold or retain the gel composition. Ideally the porous medium can allow the gel composition to move within it. In specific embodiments the porous medium comprises natural materials, synthetic, or semi-synthetic, or a combination thereof. In specific embodiments the porous medium comprises sheet material, foam, or fibres, for example loose fibres; or a combination thereof. In specific embodiments the porous medium comprises a woven, non-woven, or extruded material, or combinations thereof. Preferably the porous medium comprises, cotton, paper, viscose, PLA, or cellulose acetate, of combinations thereof. Preferably the porous medium comprises a sheet material, for example, cotton or cellulose acetate. In a particularly preferred embodiment, the porous medium comprises a sheet made from cotton fibres.

The porous medium may be crimped or shredded. In preferred embodiments, the porous medium is crimped. In alternative embodiments the porous medium comprises shredded porous medium. The crimping or shredding process can be before or after loading with the gel composition.

Crimping of the sheet material has the benefit of improving the structure to allow passageways through the structure. The passageways though the crimped sheet material assist in loading up gel, retaining gel and also for fluid to pass through the crimped sheet material. Therefore there are advantages of using crimped sheet material as the porous medium.

Shredding gives a high surface area to volume ratio to the medium thus able to absorb gel easily.

In some embodiments the sheet material is a composite material. Preferably the sheet material is porous. The sheet material may aid manufacture of the tubular element comprising a gel. The sheet material may aid introducing an active agent to the tubular element comprising a gel. The sheet material may help stabilise the structure of the tubular element comprising a gel. The sheet material may assist transport or storage of the gel. Using a sheet material enables, or aids, adding structure to the porous medium for example by crimping of the sheet material.

The porous medium may be a thread. The thread may comprise for example cotton, paper or acetate tow. The thread may also be loaded with gel like any other porous medium. An advantage of using a thread as the porous medium is that it may aid ease of manufacturing.

The thread may be loaded with gel by any known means. The thread may be simply coated with gel, or the thread may be impregnated with gel. In the manufacture, the threads may be impregnated with gel and stored ready for use to be included in the assembly of a tubular element.

Preferably, in embodiments in which the first element comprises a gel composition, as described above, the downstream section of the aerosol-generating article comprises a first tubular element according to the invention, where the first tubular element has a length of less than 10 millimetres. The use of such a relatively short tubular element in combination with a gel composition may optimise the delivery of aerosol to the consumer.

Embodiments of the invention in which the aerosol-generating substrate comprises a gel composition, as described above, preferably comprise an upstream element upstream of the first element comprising the aerosol-generating substrate. In this case, the upstream element advantageously prevents physical contact with the gel composition. The upstream element can also advantageously compensate for any potential reduction in RTD, for example, due to evaporation of the gel composition upon heating of the first element comprising the aerosol-generating substrate during use.

Features described in relation to one example or embodiment may also be applicable to other examples and embodiments.

Below, there is provided a non-exhaustive list of non-limiting examples. Any one or more of the features of these examples may be combined with any one or more features of another example, embodiment, or aspect described herein.

EX1. A tubular element for an aerosol-generating article, the tubular element comprising: a tubular body defining a cavity extending from a first end of the tubular body to a second end of the tubular body; a folded end portion forming a first end wall at the first end of the tubular body, the first end wall delimiting an opening for airflow between the cavity and the exterior of the tubular element.

EX2. A tubular element according to EX1, wherein the cavity has an area as measured perpendicular to the longitudinal direction of the tubular element, and wherein the opening has an area, as measured perpendicular to the longitudinal direction of the tubular element, of from about percent to about 60 percent of the area of the cavity.

EX3. A tubular element according to EX1 or EX2, wherein the opening has a diameter of from about 0.5 millimetres to about 5 millimetres.

EX4. A tubular element according to any of EX1 to EX3, wherein the tubular body has an outer diameter, and wherein the opening of the first end wall has a diameter of from about 7 percent to about 70 percent of the outer diameter of the tubular body.

EX5. A tubular element according to any of EX1 to EX4, wherein the tubular body of the tubular element is substantially air impermeable.

EX6. A tubular element according to any of EX1 to EX5, wherein the tubular element is formed from a paper material.

EX7. A tubular element according to any of EX1 to EX6, wherein at least the first portion of the tubular element forming the first end wall is air impermeable.

EX8. A tubular element according to any of EX1 to EX7, wherein the first end wall extends partially into the cavity of the tubular body and forms an angle of less than 90 degrees with the inner surface of the tubular body.

EX9. An aerosol-generating article aerosol-generating article comprising; a first element comprising an aerosol-generating substrate; and a tubular element according to any of EX1 to EX8, the tubular element being positioned upstream or downstream of the first element.

EX10. An aerosol-generating article according to EX9, wherein the tubular element is adjacent to the first element.

EX11. An aerosol-generating article according to EX10, wherein the first end wall of the tubular element is adjacent to the first element.

EX12. An aerosol-generating article according to EX11, wherein the first end wall of the tubular element is in contact with the aerosol-generating substrate.

EX13. An aerosol-generating article according to any of EX9 to EX12, wherein the aerosol-generating substrate is a rod of aerosol-generating substrate, and wherein the first element further comprises a susceptor element arranged within the rod of aerosol-generating substrate.

EX14. An aerosol-generating article according to EX13, wherein the susceptor element is an elongate susceptor arranged longitudinally within the aerosol-generating substrate.

EX15. An aerosol-generating article according to any of EX9 to EX14, wherein the tubular element is a first tubular element, and is positioned downstream of the aerosol forming substrate with the first end wall of the first tubular element being adjacent to the downstream end of the aerosol-generating substrate.

EX16. An aerosol-generating article according to EX15, wherein the ventilation zone is located in a downstream section of the first tubular element.

EX17. An aerosol-generating article according to EX15 or EX16, further comprising a second tubular element, the second tubular element comprising: a tubular body defining a cavity extending from a first end of the tubular body to a second end of the tubular body; and a folded end portion forming a first end wall at the first end of the tubular body, the first end wall delimiting an opening for airflow between the cavity and the exterior of the second tubular element, wherein the second tubular element is positioned upstream of the aerosol-generating substrate with the first end wall of the second tubular element being adjacent to the upstream end of the aerosol-generating substrate.

EX18. An aerosol-generating article according to EX17, wherein the second tubular element further comprises a folded end portion forming a second end wall at the second end of the tubular body, the second end wall delimiting an opening for airflow between the cavity and the exterior of the second tubular element.

EX19. An aerosol-generating article according to EX18, wherein the opening delimited by the second end wall of the second tubular element is smaller than the opening delimited by the first end wall of the second tubular element.

EX20. An aerosol-generating article according to any of EX17 to EX19, wherein the second tubular element is the most upstream component of the aerosol-generating article.

EX21. An aerosol-generating article according to any of EX15 to EX20, further comprising a ventilation zone at a location along the first tubular element.

EX22. An aerosol-generating article according to any of EX15 to EX22, further comprises a mouthpiece element located downstream of the first tubular element.

EX23. An aerosol-generating article according to EX22, wherein the mouthpiece element comprises a segment of filtration material.

EX24. An aerosol-generating article according to any of EX1 to EX23, wherein the cavity in the tubular body is an empty cavity.

EX25. An aerosol-generating article according to any of EX1 to EX24, wherein there is no ventilation zone about the tubular body of the tubular element.

EX26. An aerosol-generating article according to any of EX1 to EX24, further comprising a ventilation zone at a location along the tubular body of the tubular element.

EX27. An aerosol-generating article according to EX26, wherein the ventilation zone comprises a plurality of perforations through the tubular body.

EX28. A tubular element according to EX26 or EX27, wherein the ventilation zone is located between about 5 millimetres and about 15 millimetres from the folded end portion of the tubular element.

EX29. A tubular element according to any of EX26 to EX28, wherein ventilation zone comprises at least one circumferential row of perforations extending around the tubular.

EX30. A tubular element according to any of EX26 to EX29, wherein the tubular element has a ventilation level from about 20 percent to about 70 percent.

EX31. An aerosol-generating article according to any of EX1 to EX30, further comprising an outer wrapper circumscribing at least the tubular element.

It will be understood that features described in relation to one example or embodiment may also be applicable to other examples and embodiments. For example, it will be understood that features which have been described so far in relation to one or more of the apparatus, the use of the apparatus and components of the apparatus configured to perform specific functions, also equates to disclosure of methods of operating the apparatus. For example, disclosure of a crimping device configured to crimp the band of material also equates to disclosure of a method step of crimping the band of material with the crimping device.

The invention will now be further described, by way of example only, with reference to the accompanying drawings in which:

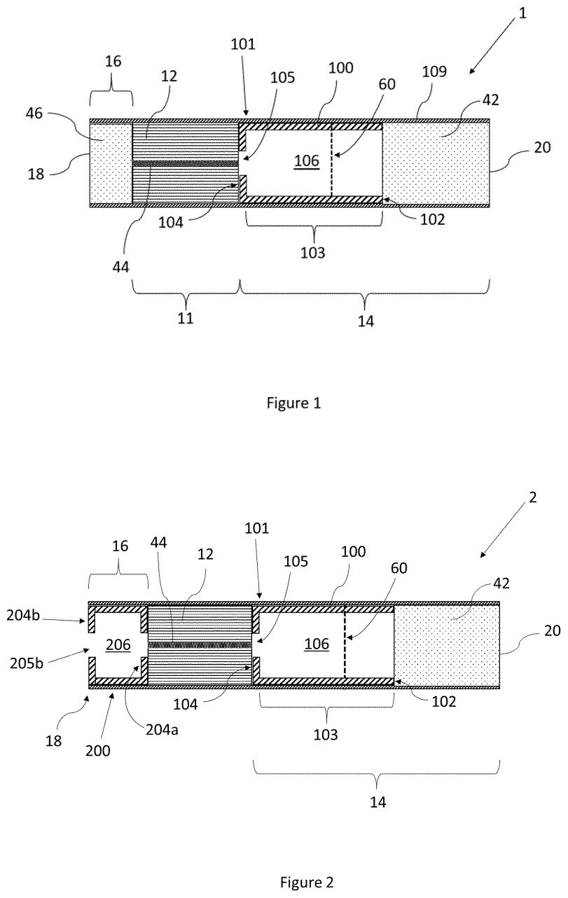

FIG. 1 shows a schematic side sectional view of an aerosol-generating article in accordance with a first embodiment of the invention;

FIG. 2 shows a schematic side sectional view of an aerosol-generating article in accordance with a second embodiment of the invention;

FIG. 2 shows a schematic side sectional view of an aerosol-generating article in accordance with a third embodiment of the invention;

FIG. 4 shows a perspective view of a tubular element of the aerosol-generating article of the first embodiment of the invention; and

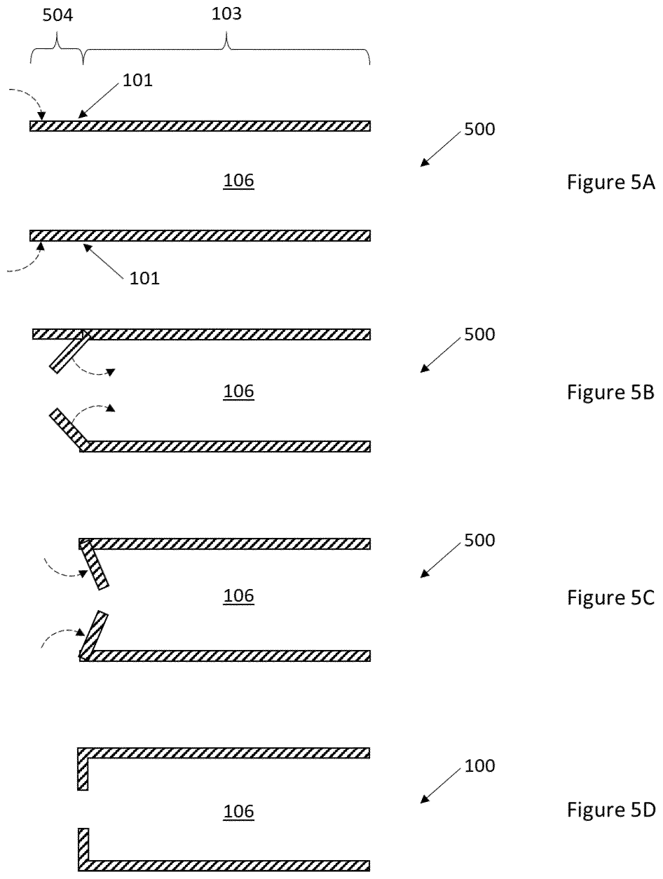

FIGS. 5A to 5D show schematic side sectional views depicting the stages of formation of the tubular element of the aerosol-generating article of FIG. 1;

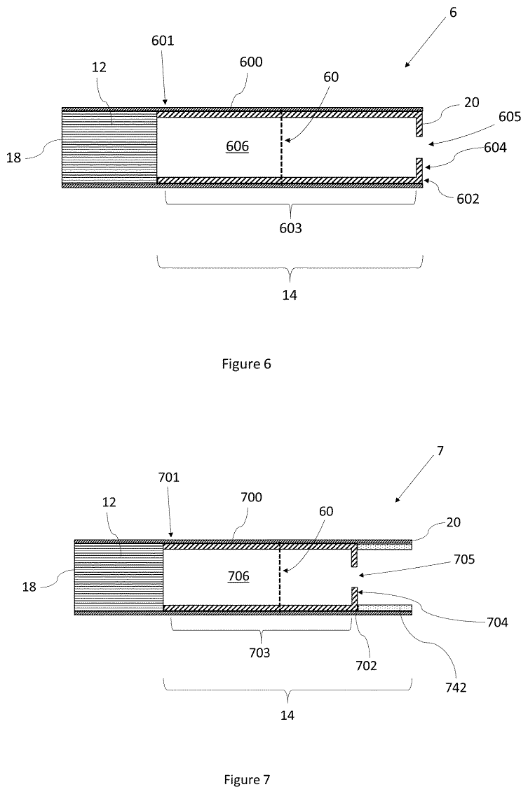

FIG. 6 shows a schematic side sectional view of an aerosol-generating article in accordance with a fourth embodiment of the invention;

FIG. 7 shows a schematic side sectional view of an aerosol-generating article in accordance with a fifth embodiment of the invention;

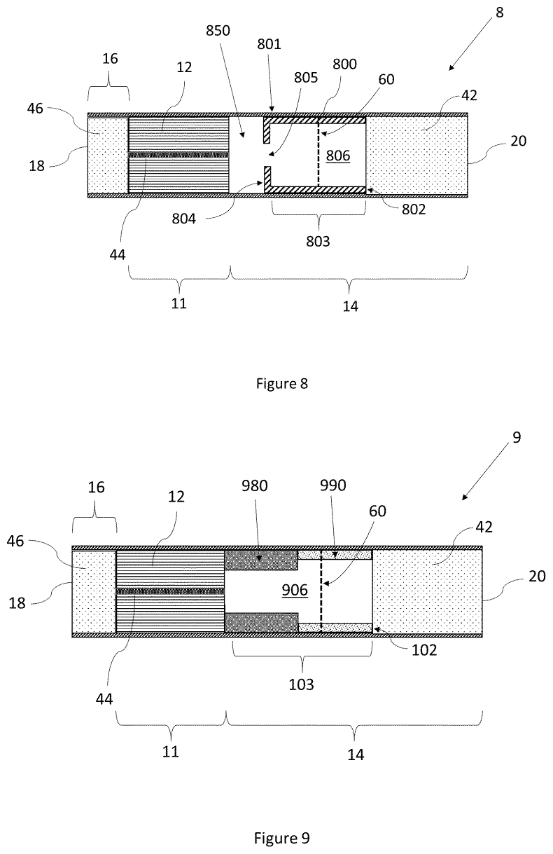

FIG. 8 shows a schematic side sectional view of an aerosol-generating article in accordance with a sixth embodiment of the invention;

FIG. 9 shows a schematic side sectional view of an aerosol-generating article not in accordance with an embodiment of the invention;

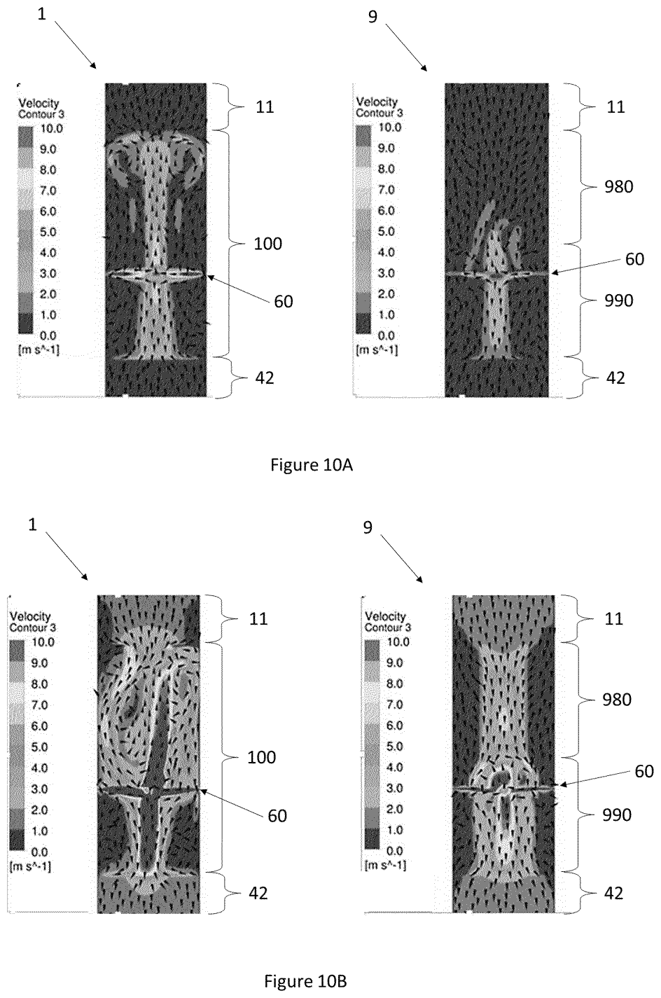

FIGS. 10A and 10B depict air flow fields comparing an aerosol-generating article in accordance with an embodiment of the invention with an aerosol-generating article not in accordance the invention;

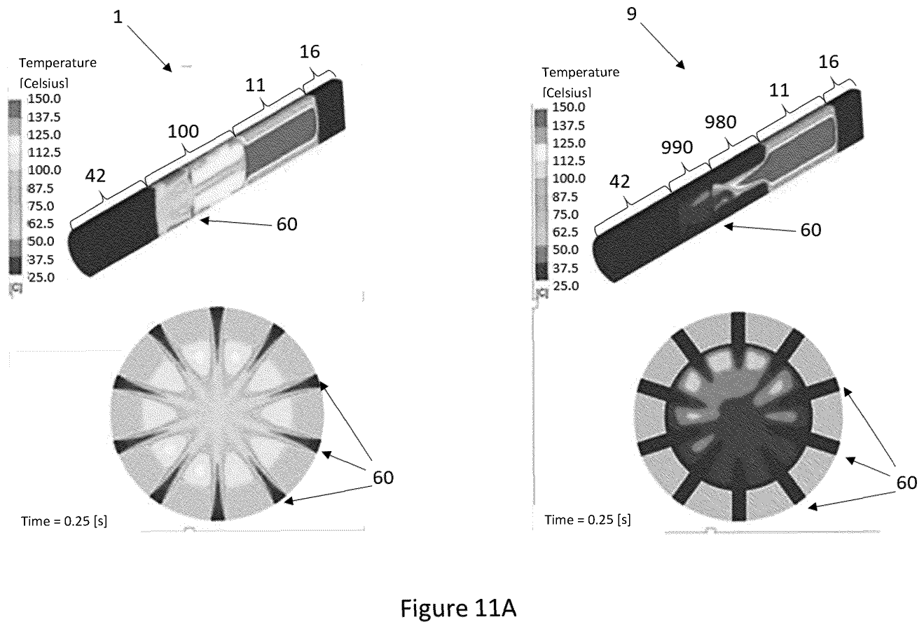

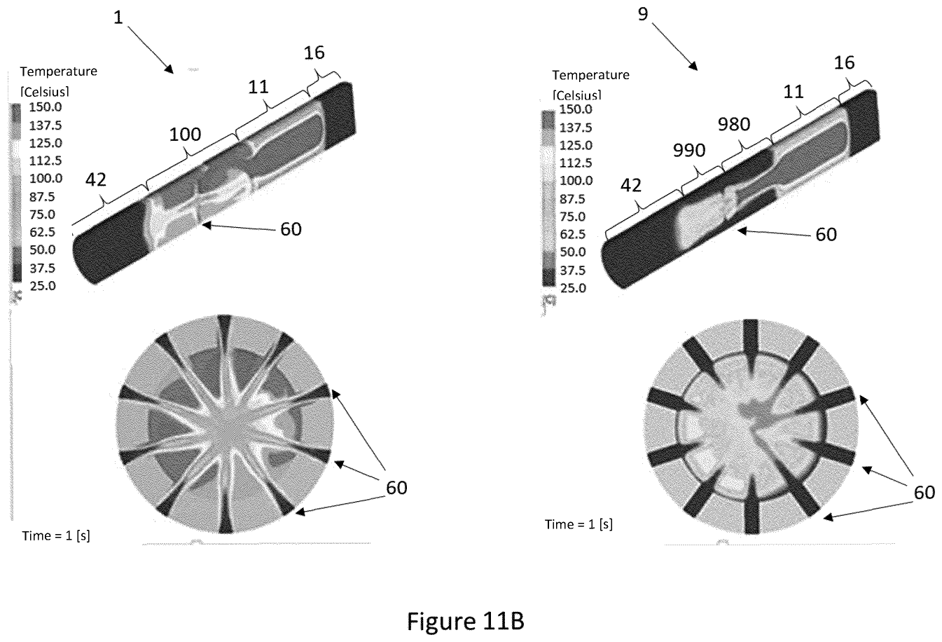

FIGS. 11A and 11B depict air flow fields comparing an aerosol-generating article in accordance with an embodiment of the invention with an aerosol-generating article not in accordance the invention; and

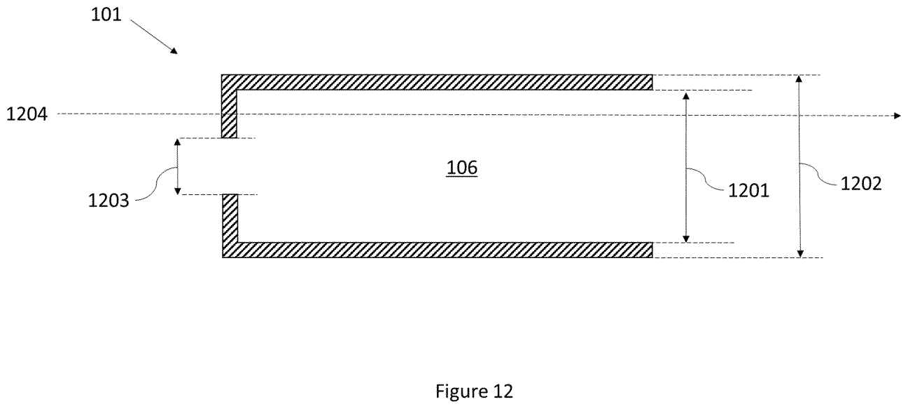

FIG. 12 shows a schematic side sectional view of the tubular element of FIG. 1.

FIG. 1 shows an aerosol-generating article 1 article in accordance with a first embodiment of the invention. The aerosol-generating article 1 comprises a first element 11 comprising an aerosol-generating substrate 12 and a downstream section 14 at a location downstream of the first element 11. Further, the aerosol-generating article 1 comprises an upstream section 16 at a location upstream of the first element 11. Thus, the aerosol-generating article 1 extends from an upstream or distal end 18 to a downstream or mouth end 20.

The aerosol-generating article has an overall length of about 45 millimetres.

The downstream section 14 comprises a tubular element 100 located immediately downstream of the first element 11, the tubular element 100 being in longitudinal alignment with the first element 11. In the embodiment of FIG. 1, the upstream end of the tubular element 100 abuts the downstream end of the first element 11 and in particular the downstream end of the aerosol-generating substrate 12.

In addition, the downstream section 14 comprises a mouthpiece element 42 at a location downstream of the tubular element 100. In more detail, the mouthpiece element 42 is positioned immediately downstream of the tubular element 100. As shown in FIG. 1, an upstream end of the mouthpiece element 42 abuts the downstream end 40 of the tubular element 100.

The mouthpiece element 42 is provided in the form of a cylindrical plug of low-density cellulose acetate. The mouthpiece element 42 has a length of about 12 millimetres and an external diameter of about 7.25 millimetres. The RTD of the mouthpiece element 42 is about 12 millimetres H₂O.

The aerosol-generating article 1 comprises a ventilation zone 60 provided at a location along the tubular element 100. In more detail, the ventilation zone is provided at about 4 millimetres from the downstream end of the tubular element 100. A ventilation level of the aerosol-generating article 10 is about 40 percent.

The first element 11 is in the form of a rod comprising the aerosol-generating substrate 12 of one of the types described above. The aerosol-generating substrate 12 may substantially define the structure and dimensions of the rod 11. The rod 11 may further comprise a wrapper (not shown) circumscribing the aerosol-generating substrate 12. The rod 11 comprising the aerosol-generating substrate has an external diameter of about 7.25 millimetres and a length of about 12 millimetres.

The first element 11 also comprises an elongate susceptor element 44 within the aerosol-generating substrate 12. In more detail, the susceptor element 44 is arranged substantially longitudinally within the aerosol-generating substrate 12, such as to be approximately parallel to the longitudinal direction of the rod 11. As shown in the drawing of FIG. 1, the susceptor element 44 is positioned in a radially central position within the rod and extends effectively along the longitudinal axis of the rod 11.

The susceptor element 44 extends all the way from an upstream end to a downstream end of the aerosol-generating substrate 12. In effect, the susceptor element 44 has substantially the same length as the first element 11 comprising the aerosol-generating substrate 12.

In the embodiment of FIG. 1, the susceptor element 44 is provided in the form of a strip and has a length of about 12 millimetres, a thickness of about 60 micrometres, and a width of about 4 millimetres.

The upstream section 16 comprises an upstream element 46 located immediately upstream of the first element 11, the upstream element 46 being in longitudinal alignment with the first element 11. In the embodiment of FIG. 1, the downstream end of the upstream element 46 abuts the upstream end of the first element 11 and in particular the upstream end of the aerosol-generating substrate 12. This advantageously prevents the susceptor element 44 from being dislodged. Further, this ensures that the consumer cannot accidentally contact the heated susceptor element 44 after use.

The upstream element 46 is provided in the form of a cylindrical plug of cellulose acetate circumscribed by a stiff wrapper. The upstream element 46 has a length of about 5 millimetres. The RTD of the upstream element 46 is about 30 millimetres H₂O.

The aerosol-generating article 1 further includes an outer wrapper 109 circumscribing at least the tubular element. As shown in FIG. 1, the outer wrapper also circumscribes the first element 11, the mouthpiece element 42 and the upstream element 46. The outer wrapper 109 extends from an upstream or distal end 18 to a downstream or mouth end 20.

The tubular element 100 comprises a tubular body 103 defining a cavity 106 extending from a first end 101 of the tubular body 103 to a second end 102 of the tubular body 103. The tubular element 100 also comprises a folded end portion forming a first end wall 104 at the first end 101 of the tubular body 103. The first end wall 104 delimits and opening 105, which permits airflow between the cavity 106 and the exterior of the tubular element 100. In particular, the embodiment of FIG. 1 is configured so that aerosol may flow from the first element 11 through the opening 105 into the cavity 106.

The cavity 106 of the tubular body 103 is substantially empty, and so substantially unrestricted airflow is enabled along the cavity 106. Consequently, the RTD of the tubular element 100 can be localised at a specific longitudinal position of the tubular element 100—namely, at the first end wall 104—and can be controlled through the chosen configuration of the first end wall 104 and its corresponding opening 105. In the embodiment of FIG. 1, the RTD of the tubular element 100 (which is essentially the RTD of the first end wall 104) is substantially 10 millimetres H₂O. In the embodiment of FIG. 1, the tubular element 100 has a length of about 16 millimetres, an external diameter of about 7.25 millimetres, and an internal diameter (D_{FTS}) of about 6.5 millimetres. Thus, a thickness of a peripheral wall of the tubular body 103 is about 0.375 millimetres.

As shown in FIG. 1, and also in more detail in the perspective view of FIG. 4, the first end wall 104 extends substantially transverse to the longitudinal direction of the aerosol generating article 1 and the longitudinal direction of the tubular element 100. The opening 105 is the only opening in the first end wall 104 and the opening 105 is positioned in a generally radially central position of the tubular element 100. Consequently, the first end wall 104 is generally annular shaped.

The combination of the first end wall 104 and its corresponding opening 105 provide an effective barrier arrangement which may restrict movement of the aerosol-generating substrate, whilst also enabling one or both of air and aerosol to flow from the first element 11 and through the opening 105 into the cavity 106. The opening 105 is generally aligned with the radially central position of the susceptor element 44 of the first element 11. This may be advantageous as it helps to keep a distance between the first end wall 105 and the susceptor, and thus mitigate undesirable heating of the first end wall 105. This may also be advantageous as it can provide direct unimpeded downstream flow of aerosol produced by the portion of the aerosol-generating substrate in close proximity to the susceptor element 44.

As will be described in more detail below with respect to FIGS. 5A-5D, the first end wall 104 is formed by folding an end portion of the tubular element 100 about a fold point. The fold point generally corresponds to the first end of the tubular body 103 of the tubular element 100.

FIG. 2 shows an aerosol-generating article 2 in accordance with a second embodiment of the invention. The aerosol-generating article 2 of the second embodiment is generally the same as the aerosol-generating article 1 of the first embodiment, with the exception that the aerosol-generating article 2 of the second embodiment does not comprise an upstream element 46 is provided in the form of a cylindrical plug of cellulose acetate circumscribed by a stiff wrapper. Instead, the aerosol-generating article 2 of the second embodiment comprises a second tubular element 200 located immediately upstream of the first element 11. Consequently, in this second embodiment, the tubular element 100 located immediately downstream of the first element 11 is referred to as a first tubular element 100.

The second tubular element 200 comprises a tubular body 203 defining a cavity 206 extending from a first end of the tubular body 203 to a second end of the tubular body 203. The tubular element 200 also comprises a folded end portion forming a first end wall 204a at the first end of the tubular body 103. The first end wall 204a delimits and opening 205a, which permits airflow between the cavity 206 and the exterior of the second tubular element 200. In particular, the embodiment of FIG. 2 is configured so that air may flow from the cavity 206 through the opening 205a and into the first element 11.

The second tubular element 200 is therefore similar to the first tubular element 100 in that an end portion of the tubular element 200 is folded to form an end wall 205a, which extends substantially transverse to the longitudinal direction of the aerosol-generating article, and which is disposed adjacent to an end of the aerosol-generating substrate 12. In this case, the second tubular element 200 is disposed upstream, rather than downstream, of the first element 11 comprising the aerosol-generating substrate 12, meaning that the end wall 204a is disposed adjacent to the upstream end of the aerosol-generating substrate 12.

However, unlike the first tubular element, the second tubular element 200 also comprises a second end wall 204b at the second end of its tubular body 203. This second end wall 204b is formed by folding an end portion of the second tubular element 200 at the second end of the tubular body of the second tubular element 200. The second end wall 204b delimits and opening 205b, which also permits airflow between the cavity 206 and the exterior of the second tubular element 200. In the case of the second end wall 204b, the opening 205b is configured to so that air may flow from the exterior of the aerosol-generating article 2 through the opening 205b and into the cavity 206. The opening 205b therefore provides the conduit through which air can be drawn into the aerosol-generating article 2 and through the aerosol-generating substrate 12. In the embodiment of FIG. 2, the first end wall 204a of the second tubular element 200 may be referred to as the downstream end wall of the second tubular element 200. Similarly, the second end wall 204b of the second tubular element 200 may be referred to as the upstream end wall of the second tubular element 200.

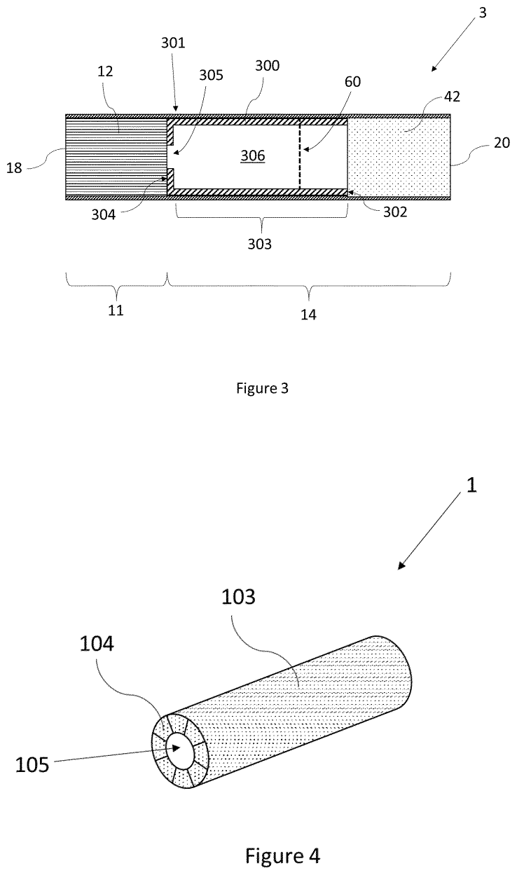

FIG. 3 shows an aerosol-generating article 3 in accordance with a third embodiment of the invention. The aerosol-generating article 3 of the third embodiment is generally the same as the aerosol-generating article 1 of the first embodiment, with the exception that the aerosol-generating article 3 of the third embodiment does not comprise any form of upstream element 46 upstream of the first element 11. Consequently, the upstream or distal end 18 of the aerosol-generating article 3 is defined by the first element 11. Furthermore, in the third embodiment of the invention the first element 11 does not comprise a susceptor element 44 located within the aerosol-generating substrate 12. Such an aerosol-generating article 3 may therefore be one which is configured to receive a heater blade of an aerosol-generating device. The heater blade may be inserted into the aerosol-generating substrate 12 through the upstream end 18 of the aerosol-generating article 3.

The tubular element 300 of the aerosol-generating article 3 of the third embodiment is substantially the same as the tubular element 100 of the aerosol-generating article 1 of the first embodiment, with the exception that the tubular element 300 is longer than the tubular element 100.

FIGS. 5A to 5D show a tubular element for an aerosol generating article in according with the invention, through different stages of its formation. These Figures therefore illustrate a method of forming the tubular element, such as the tubular element 100 of FIG. 1.

As illustrated by FIG. 5A, the method commences by providing a tubular element 500 comprising a first end portion 504 and a tubular body 103 adjacent to and integral with the first end portion 504. To form the first end wall 104, a folding force is applied to the tubular element 500 to bend the first end portion 504 about a fold point 501 corresponding to the first end of the tubular body 103.

The folding force deflects the first end portion 504 inwards relative to the tubular body 103 (as indicated by the dashed curved arrows in FIGS. 5A, 5B and 5C) and towards the cavity 106 of the tubular body 103. The folding force continues to be applied until the first end portion 504 has been folded by an angle of greater than 90 degrees, as measured relative to the walls of the tubular body 103. Such a position is depicted in FIG. 5C. As can be seen from FIG. 5C, in such a position, at least part of the first end portion 504 of the tubular element 500 extends into the cavity 106 of the tubular body 103. Put another way, at least part of the first end portion 504 of the tubular element 500 has a longitudinal position which resides between that of the first end of the tubular body 103 and that of the second end of the tubular body 103.

Once the first end portion 504 reaches the position of FIG. 5C, the folding force ceases to be applied. At this point, the inherent resilient properties of the paper material (such as paper, paperboard or cardboard) of the tubular element 500 will cause the first end portion 504 to partially revert back along its folding path, such that the first end portion 504 reaches a positon in which it extends substantially transverse to the longitudinal direction of the tubular body 103. This position is illustrated by FIG. 5D, which depicts the fully formed tubular element 100. In particular, the folded first end portion 504 forms a first end wall 104 at the first end of the tubular body 103, the first end wall 104 delimiting an opening 105 for airflow between the cavity 106 and the exterior of the tubular element 100.

In the arrangement of FIGS. 5A to 5D the second end of the tubular element 500 is not folded; however, it will be appreciated that similar method steps may be applied to this second end of the tubular element 500 in order to arrive at a tubular element having two folded end portions, each forming respective first and second end walls for the tubular element.

FIG. 6 shows an aerosol-generating article 6 in accordance with a fourth embodiment of the invention. The aerosol-generating article 6 of the fourth embodiment is generally the same as the aerosol-generating article 3 of the third embodiment and like-for-like reference numerals are used where appropriate. However, the aerosol-generating article 6 of the fourth embodiment does not comprise a mouthpiece element 42 at a location downstream of the tubular element 600. Instead, the tubular element 600 of FIG. 6 extends all the way from the downstream end of the aerosol-forming substrate 12 to the mouth end 20 of the aerosol-generating article 6. The downstream section 14 of the aerosol-generating article 6 in FIG. 6 is therefore entirely formed by the tubular element 600.

Furthermore, in the embodiment of FIG. 6, the first end wall 604 of the tubular element 600 is not disposed adjacent to the downstream end of the aerosol-forming substrate 12. Instead, the first end wall 604 of the tubular element 600 is disposed at the mouth end 20 of the aerosol-generating article 6. The first end wall 604 delimits and opening 605, which permits airflow between the cavity 606 and the exterior of the tubular element 600. The opening 605 is configured so that one or both of air and aerosol may flow from the cavity 606 through the opening 605b to the exterior of the aerosol-generating article 6.

FIG. 7 shows an aerosol-generating article 7 in accordance with a fifth embodiment of the invention. The aerosol-generating article 7 of the fifth embodiment is generally the same as the aerosol-generating article 6 of the fourth embodiment and like-for-like reference numerals are used where appropriate. However, the aerosol-generating article 7 of the fifth embodiment now comprises a mouthpiece element in the form of a hollow tube 742 at a location downstream of the tubular element 700. The tubular element 700 of FIG. 7 therefore extends all the way to the upstream end of this hollow tube 742. The downstream section 14 of the aerosol-generating article 6 in FIG. 6 is therefore defined by the tubular element 700 and the hollow tube 742.

FIG. 8 shows an aerosol-generating article 8 in accordance with a sixth embodiment of the invention. The aerosol-generating article 8 of the sixth embodiment is generally the same as the aerosol-generating article 1 of the first embodiment and like-for-like reference numerals are used where appropriate.

However, in the embodiment of FIG. 8, the tubular element 800 is not in contact with the first element 11 comprising the aerosol-generating substrate 12. Instead, an empty space 850 exists between the downstream end of the first element 11 and the first end wall 804 at the upstream end 801 of the tubular element 800. Consequently, in the embodiment of FIG. 8, the first end wall 804 of the tubular element 800 does not provide a barrier which is in contact with the aerosol-generating substrate 12 for restricting movement of the aerosol-generating substrate 12. However, the empty space 850 does provide a region in which any loose particles or pieces from the aerosol-generating substrate 12 may congregate during use of the aerosol-generating article 8. The first end wall 804 may, with the assistance of gravity, prevent such loose particles or pieces from moving further downstream within the aerosol-generating article 8.

FIG. 9 shows an aerosol-generating article 9 not in accordance the invention. The aerosol-generating article 9 has similarities with the aerosol-generating article 1 of the first embodiment of the invention in FIG. 1, and like-for-like reference numerals are used where appropriate. However, the aerosol-generating article 9 of FIG. 9 does not comprise a tubular element in accordance with the invention. In particular, in contrast to the aerosol-generating article 1 of FIG. 1, the aerosol-generating article 9 of FIG. 9 does not comprise a tubular element 100 between the first element 100 and the mouthpiece element 42. Instead, the aerosol-generating article 9 of FIG. 9 comprises two hollow acetate tubes between the first element 100 and the mouthpiece element 42. These are a first hollow acetate tube 980 located immediately downstream of the first element 11 and a second hollow acetate tube 990 located immediately downstream of the first hollow acetate tube 980.

FIGS. 10A and 10B depict air flow fields generated in a Computational Fluid Dynamics (CFD) simulation comparing an aerosol-generating article in accordance with FIG. 1 comprising tubular element (hereinafter referred to as Example A) with an aerosol-generating article in accordance with FIG. 9 comprising two known hollow acetate tubes (hereinafter referred to as Comparative Example A). FIG. 10A shows the air flow fields 0.25 seconds into a simulated puff, and FIG. 10B shows the air flow fields 1 second into a simulated puff.

The aerosol-generating article of Example A consists of the following elements placed adjacent to one another starting from the upstream end of the aerosol-generating article: a cylindrical plug of cellulose acetate (length: 5 millimetres); an aerosol-forming substrate formed of a gathered crimped sheet of tobacco surrounding a susceptor (length: 12 millimetres); a tubular element having a folded end portion forming a first end wall adjacent to the aerosol-forming substrate (length: 16 millimetres); and a mouth end plug of cellulose acetate (length: 12 millimetres).

The aerosol-generating article of Comparative Example A consists of like-for-like elements to the article of Example A except that the tubular element has been replaced with two hollow acetate tubes of a combined equivalent length. Therefore, the aerosol-generating article of Comparative Example A consists of the following elements placed adjacent to one another starting from the upstream end of the aerosol-generating article: a cylindrical plug of cellulose acetate (length: 5 millimetres); an aerosol-forming substrate formed of a gathered crimped sheet of tobacco surrounding a susceptor (length: 12 millimetres); a first hollow acetate tube (length: 8 millimetres); a second hollow acetate tube (length: 8 millimetres); and a mouth end plug of cellulose acetate (length: 12 millimetres).

A single line of ventilation providing a ventilation level of 40 percent is provided around the tubular element of Example A and is disposed 5 millimetres from the downstream end of the tubular element. A single line of ventilation providing a ventilation level of 40 percent is also provided around the second hollow acetate tube of Comparative Example A and is disposed 5 millimetres from the downstream end of the second hollow acetate tube.

As can be seen from FIG. 10A, after 0.25 seconds of a puff, mixing of air drawn through the aerosol-forming substrate with fresh air drawn through the ventilation holes is noticeably more prominent in Example A than in Comparative Example A. Higher speed values are also more notable in Example A when compared with Comparative Example A.

This phenomenon develops further as the puff progresses in time, as illustrated by FIG. 10B. In particular, in FIG. 10B, after 1 second of a puff, jet instabilities and further velocity increases can be seen with Example A, which are not present in Comparative Example A. Such jet instabilities may improve the mixing of hot air drawn through the aerosol-forming substrate with fresh air drawn through the ventilation holes. This may lead to more favourable conditions for nucleation and growth of aerosol particles within the tubular element, when compared to that of the hollow acetates tube of Comparative Example A. Without wishing to be bound by theory, it is thought that such favourable conditions are particularly promoted in Example A through the combined use of the first end wall of the tubular element and the ventilation line disposed around the tubular element. In particular, the first end wall of the tubular element can provide a partial restriction of where air can flow into and out of the tubular element. This partial restriction, when combined with presence of ventilation downstream of the restriction, appears to be particularly effective at promoting the mixing of hot air drawn through the aerosol-forming substrate with fresh air drawn through the ventilation holes.

FIGS. 11A and 11B depict air temperature fields generated in a Computational Fluid Dynamics (CFD) simulation, and provide a comparison of these for the aerosol-generating article of Example A with the aerosol-generating article of Comparative Example A. FIG. 11A shows the air temperature fields 0.25 seconds into a simulated puff, and FIG. 10B shows the air temperature fields 1 second into a simulated puff. As can be clearly seen in FIGS. 11A and 11B, a more evenly distributed and higher temperature is achieved within the tubular element of Example A when compared with the hollow acetate tubes of Comparative Example A. This is noticeable after 0.25 seconds of a puff, and also noticeable after 1 second of a puff.

FIG. 12 shows a schematic side sectional view of the tubular element of FIG. 1, and illustrates various dimensions of the tubular element. In particular, a first double ended arrow 1201 is included in FIG. 12 to illustrate the internal diameter of the cavity 106 of the tubular body, a second double ended arrow 1202 is included in FIG. 12 to illustrate the outer diameter of the tubular body, and a third double ended arrow 1203 is included in FIG. 12 to illustrate the diameter of the opening 105 of the first end wall. These diameters may be used to calculate corresponding areas, as measured perpendicular to the longitudinal direction of the tubular element. In particular, the internal diameter of the cavity 106 can be used to calculate the area of the cavity, as measured perpendicular to the longitudinal direction of the tubular element.

In FIG. 12, the tubular element 100 has an external diameter 1202 of about 7.25 millimetres, and an internal diameter 1201 of about 6.5 millimetres. Thus, a thickness of a peripheral wall of the tubular body 103 is about 0.375 millimetres. The diameter 1203 of the opening is about 2.2 millimetres. Thus, the area of the opening in FIG. 12 is about 3.8 millimetres squared. The area of the cavity defined by the internal diameter 1201 of the tubular body is about 33.2 millimetres squared. The area corresponding to the outer diameter 1202 of the tubular body is about 41.3 millimetres squared.

The following table, Table 1, details the measured yields of Nicotine and Glycerol produced by the following four aerosol-generating articles when subjected to identical smoking tests: Example B, Example C, and Comparative Example 1.

The aerosol-generating article of Example B consists of the following elements placed adjacent to one another starting from the upstream end of the aerosol-generating article: a cylindrical plug of an aerosol-forming substrate; a tubular element having a folded end portion forming a first end wall adjacent to the aerosol-forming substrate, the first end wall delimiting an opening; and a mouth end plug of cellulose acetate. The opening of the first end wall has a diameter of 1.5 millimetres.

The aerosol-generating article of Example C is identical to the aerosol-generating article of Example B, except that the opening of the first end wall has a diameter of 3 millimetres.

The aerosol-generating article of Comparative Example 1 is identical to the aerosol-generating article of Example B, except that the tubular element does not have a folded end portion forming a first end wall. The tubular element is instead a hollow tube having a constant cross section along its length with an empty internal cavity.

TABLE 1

| Type of Aerosol- | Comparative | | |
|---|---|---|---|
| generating Article | Example 1 | Example B | Example C |
| Nicotine yield | 1073 | 1254 | 1128 |
| (μg/stick) | | | |
| Glycerol yield | 4240 | 5768 | 4759 |
| (μg/stick) | | | |

As illustrated by Table 1, both Example B and Example C were found to produce aerosols having nicotine yields and glycerol yields noticeably higher than those of Comparative Example 1. Example B was found to produce particularly high yields for both nicotine and glycerol in comparison to Comparative Example 1. It has also been noted by the inventors that the glycerol yield per puff peaked and plateaued at an earlier puff in the smoking cycle for an aerosol-generating article with a tubular element having a 2 millimetre diameter opening when compared to an identical aerosol-generating article having a tubular element with a 3 millimetre diameter opening.

1.-15. (canceled)

16. An aerosol generating article comprising a tubular element, the tubular element comprising:
a tubular body defining a cavity extending from a first end of the tubular body to a second end of the tubular body, the cavity having an area as measured perpendicular to a longitudinal direction of the tubular element; and
a folded end portion forming a first end wall at a first end of the tubular body, the first end wall delimiting an opening for airflow between the cavity and an exterior of the tubular element,
wherein the opening has an area, as measured perpendicular to the longitudinal direction of the tubular element, of from about 0.6 percent to about 60 percent of an area of the cavity.

17. The aerosol generating article according to claim 16, wherein the opening has an area, as measured perpendicular to the longitudinal direction of the tubular element, of from about 2.5 percent to about 9.5 percent of the area of the cavity.

18. The aerosol generating article according to claim 16, wherein the opening has a diameter of from about 0.5 millimetre to about 5 millimetres.

19. The aerosol generating article according to claim 18, wherein the opening has a diameter of from about 1 millimetre to about 2 millimetres.

20. The aerosol generating article according to claim 16,
wherein the tubular body has an outer diameter, and
wherein the opening of the first end wall has a diameter of from about 7 percent to about 70 percent of the outer diameter of the tubular body.

21. The aerosol generating article according to claim 16, wherein the tubular element is formed from a paper material.

22. The aerosol generating article according to claim 16, wherein at least a first portion of the tubular element forming the first end wall is air impermeable.

23. The aerosol generating article according to claim 16, wherein the first end wall extends partially into the cavity of the tubular body and forms an angle of less than 90 degrees with an inner surface of the tubular body.

24. The aerosol generating article according to claim 16,
further comprising a first element comprising an aerosol-generating substrate,
wherein the tubular element is positioned upstream or downstream of the first element.

25. The aerosol generating article according to claim 24, wherein the tubular element is adjacent to the first element.

26. The aerosol generating article according to claim 25, wherein the first end wall of the tubular element is adjacent to the first element.

27. The aerosol generating article according to claim 26, wherein the first end wall of the tubular element is in contact with the aerosol-generating substrate.

28. The aerosol generating article according to claim 24,
wherein the aerosol-generating substrate is a rod of aerosol-generating substrate, and
wherein the first element further comprises a susceptor element arranged within the rod of aerosol-generating substrate.

29. The aerosol generating article according to claim 24, wherein the tubular element is a first tubular element, and is positioned downstream of the aerosol forming substrate with the first end wall of the first tubular element being adjacent to a downstream end of the aerosol-generating substrate.

30. The aerosol generating article according to claim 16, wherein there is no ventilation zone about the tubular body of the tubular element.
